(19) United States
(12) Patent Application Publication
(10) Pub. No.: US 2023/0246167 A1
(43) Pub. Date: Aug. 3, 2023

(54) METHOD FOR PRODUCING A SILICON-BASED ELECTRODE MATERIAL

(71) Applicant: FRAUNHOFER-GESELLSCHAFT ZUR FORDERUNG DER ANGEWANDTEN FORSCHUNG E.V., Munchen (DE)

(72) Inventors: Harald Gentischer, Freiburg im Breisgau (DE); Daniel Biro, Pfaffenweiler (DE); Peter Haberzettl, Esslingen (DE); Mathias Drews, Freiburg (DE); Jörg Horzel, Gundelfingen (DE); Lukas Dold, Winden im Elztal (DE)

(21) Appl. No.: 18/000,762

(22) PCT Filed: Jun. 2, 2021
(86) PCT No.: PCT/EP2021/064851

§ 371 Date: Dec. 5, 2022

(30) Foreign Application Priority Data
Jun. 3, 2020 (DE) 10 2020 003 354.7

(51) Int. Cl. H01M 4/36; H01M 4/38; H01M 4/587

(52) U.S. Cl. CPC H01M 4/364; H01M 4/386; H01M 4/587; H01M 2004/027

(57) ABSTRACT

The subject matter of the present invention is a method for producing a silicon-carbon composite material. The composite material can be used as an active material for the negative electrode of lithium-ion batteries on a silicon basis or processed further to form such an active material. In the case of use as a lithium store, the composite material is characterized by a particularly high specific capacity and a charging and discharging cycle-dependent life span which is particularly long.

The subject matter of the present invention is a silicon-carbon composite material (Si/C composite material) and a method for producing the silicon-carbon composite material. The composite material can be used as an active material for the negative electrode of lithium-ion batteries on a silicon basis or processed further to form such an active material.

In the case of use as a lithium store, the composite material is characterized by a particularly high specific capacity and a charging and discharging cycle-dependent life span which is long for such materials.

The proposed method is able to produce a cost-efficient active material for storing lithium ions in a lithium-ion battery on an industrial scale. This material can be used as a “drop-in-replacement” for materials used according to the current prior art, in particular for graphite, in existing production plants for lithium-ion batteries. Since, as a result of the stated material, the production costs of lithium-ion batteries can be reduced, alongside simultaneously increasing both the volumetric and gravimetric energy density of the battery, all of the known applications, in which stores for electrical energy are used, in particular in the case of mobile applications as in electromobility or in portable electronic devices of any type, profit from this.

The aim of the invention is, by providing a new material for the negative electrode of lithium-ion battery cells and by means of a new method for the production thereof, to make a significant contribution to reducing the cost of lithium-ion batteries while simultaneously increasing the energy stored in the battery for each unit of weight or volume. Silicon is in principle very well suited as a material for the negative electrode, however, during operation of the battery cell, the silicon is chemically and mechanically changed so that it is available to a decreasing extent to take up lithium in the event of multiple charging and discharging of the battery cell.

Traditionally, lithium ions are incorporated in the graphite during charging of lithium-ion batteries. In this manner, up to 372 mAh charge per gram graphite can be stored in the battery. On the search for new materials which make it possible to increase the energy density of batteries, the attention of battery manufacturers in recent years has focused on silicon as a suitable replacement for graphite. Silicon opens up the possibility of incorporating more than ten times the quantity of lithium ions in proportion with its mass. The theoretical limit for the specific gravimetric capacity of the active material lies in this case around 4200 mAh per gram silicon. It was possible to approximately achieve this value in practice, but the usable capacity drops significantly after only a few cycles. The reason for this is the very significant expansion in volume of the silicon-lithium alloy during incorporation of the lithium ions into the silicon structure (Zhang L et al: Si-containing precursors for Si-based anode materials of Li-ion batteries: A review, in: Energy Storage Materials 4 (2016) S.92-102). This process leads to ever further progressive mechanical breaking apart of the silicon particles. It was indeed possible to significantly improve these properties of the material by developing a metallurgic silicon alloy with an aluminum basis, but the degradation of the material is still comparatively pronounced.

### PRIOR ART

A method is known from US 2015/0295233 A1 with the help of which, among other things, silicon particles are coated with carbon by thermal decomposition of saccharose. The material produced in this manner should be suitable for use as an active material in lithium-ion batteries. In this case, carbon particles are mixed into the starting mixture. Moreover, a carboxylic acid must be added. Very high proportions of graphite particles are used in the method described there and the coating method takes place in a single step. The composite material obtained achieves a discharge capacity of less than 500 mAh/g.

Li Y et al.: Growth of conformal graphene cages on micrometre-sized silicon particles as stable battery anodes, in Nature Energy 1, 15029 (2016) deals with the problem of the breakdown of silicon microparticles as a result of lithium absorption. To solve this, it is proposed to surround the silicon microparticles with a graphene cage which has a cavity in order to tolerate an expansion of the microparticle. In this case, breakdown of the microparticle is not prevented, but rather fragments are retained in the cage.

One criterion which is decisive for the function of lithium-ion batteries is the formation of a suitable passive layer on the surface of the active material of the negative electrodes. Were one to use silicon as a host to store lithium ions without further measures, an inexpedient layer, above all composed of lithium silicate, would form on its surface. As a result of the breaking part of the silicon particular due to the volume expansion during incorporation of lithium, new Si surfaces would furthermore continuously arise which in turn in subsequent charging cycles allow the generation of new inexpedient layers on the new Si surfaces. Their increasing formation during each charging process consumes lithium which is subsequently no longer actively available for the charge carrier transport and thus devours energy. The number of charge carriers which can be used in the battery is reduced and the transport of lithium ions into the silicon particles is obstructed. The battery thus loses storage capacity with increasing numbers of cycles until it potentially can no longer be used for its application. This must be prevented during the intended life span (expected number of cycles) of a battery and for it to have the minimum charging capacity at all times.

### DESCRIPTION OF THE INVENTION

The method according to the invention provides preventing as much as possible the progressive formation of the stated inexpedient passive layers and thus also the progressive removal of lithium which is required for the charge carrier transport by virtue of the fact that the silicon particles, prior to use in the battery, are covered with a suitable coating of carbon and are thus protected.

If this carbon coating is suitably selected, a direct chemical reaction of electrolyte with silicon can be avoided. Instead, what are known as SEI (solid electrolyte interphase) layers are formed only on the surface of the carbon coating which comes into direct contact with the electrolyte. The boundary layer can therefore be very limited in terms of its extent (initial growth) in a similar manner to the prior art for graphite-based anode materials so that from then on stable conditions in terms of charge carrier transport through these layers can be enabled without allowing the internal resistance of the battery to further increase continuously with increasing cycle numbers. Comparatively stable conditions arise after only a few cycles, in the case of which conditions the electrolyte is not further decomposed and noteworthy amounts of lithium are not continually consumed for the formation of growing passive layers which are then no longer available to the battery as storage capacity. In contrast to SEI layers of silicon particles which are not coated with carbon, advantageous conditions can thus be realized by the suitable coating for battery cycle stability. As a result of this, a passive layer which has an expedient effect on the long life span of the battery is generated on the surface of the carbon coating ideally on a one-off basis. Such stabilized SEI layers are known from the prior art for graphite anodes and they are largely composed of lithium carbonate, lithium methyl carbonate and lithium ethylene dicarbonate (Decomposition Reactions of Anode Solid Electrolyte Interphase (SEI) Components with LiPF6, J.Phys Chem. C2017, 121, pp22733-22738).

The stabilization of these SEI boundary layers between carbon and electrolyte is performed by a selection of suitable electrolyte additives which are known from the prior art.

At the same time, the carbon coating of the silicon particles brings about that the electric conductivity between the individual composite particles of the stated material is durably maintained and not continuously reduced by progressive SEI growth, as a result of which the energy efficiency of a battery produced therefrom is improved. The possibility may even arise to dispense with electrically conductive additives in the electrode of the battery, as a result of which the overall energy density of the battery is even further increased. The carbon layer which is composed in particular at least partially of structured carbon such as graphene or graphene-type compounds is permeable for lithium ions so that the operation of the battery cell is enabled while the silicon is protected from chemical attack.

The object of the invention thus lies in providing an improved material for the anode of a lithium-ion battery which makes it possible to obtain more efficient batteries with a longer life span. A further object lies in providing a simple and particularly low-cost method for the production of silicon-carbon composite material for battery applications. The object is achieved by the subject matters of this invention.

One criterion which is important for the function of lithium-ion battery cells is the formation of a suitable passive layer on the surface of the active material of the negative electrode, known as “SEI” (Solid Electrolyte Interphase). Were one to use silicon at the stated point as a host for storing Li-ions without taking further measures, a layer which is inexpedient for the function of the battery cell, comprising lithium silicates and other reaction products, would thus be formed on its surface in interaction with the electrolyte. Since, as a result of the significant expansion of volume during the incorporation of lithium into silicon, silicon particles would break up or cracks would form therein, the further formation of these inexpedient layers led during each charging process to an ever increasing consumption of the silicon and lithium for the growth of these undesirable layers. The number of charge carriers which can be used in the battery cell and the proportion of active material are reduced as a result of this. The transport of lithium ions into the silicon particles and back to the cathode side would furthermore be inhibited by the growing inexpedient layers and additionally the electronic conductivity between the particles would be reduced considerably. As a result, the battery would form an increasingly higher internal resistance.

The method according to the invention provides in particular largely prevented the formation of this inexpedient passive layer on silicon surfaces by virtue of the fact that the silicon particles are covered with a suitable layer of carbon prior to use in a battery electrode and are thus protected. As a result of this, a passive layer which has an expedient effect on the cycle durability or the maintenance of the capacity of the battery cell over a large number of cycles is then generated on the surface of the carbon ideally on a one-off basis when the battery is charged for the first time, similarly to the use of graphite instead of silicon. The carbon coating additionally brings about that the electrical conductivity between the individual particles of the stated material is maintained over the increased life span of the battery and the charge carrier transport between the battery electrodes over significantly more charging and discharging cycles remains adequately ensured. As a result of this, the energy efficiency of a battery cell produced from this composite material of silicon particles coated with carbon is significantly improved in comparison with a battery cell produced only from silicon particles. The battery cell can consequently also be charged significantly more rapidly. The carbon layer (coating), which can be composed in particular at least partially of structured carbon such as graphene or graphene-type structures and can have a scaly arrangement on the silicon surface, is permeable to lithium ions so that the operation of the battery cell is enabled, while the silicon is protected from chemical attack. As a result, a composite material with one or more silicon particles can be generated, which silicon particles are embedded into the matrix from the described carbon material.

The specific size of the active surface is furthermore relevant for the usability of this composite material in battery cells since it also determines the quantity of the passive layer which is created and is thus also a key factor for the Coulombic efficiency of the battery. The term active surface in this context means the surface of the composite particles which interacts with the electrolyte of the battery cell. This size can be determined, for example, by a BET measurement (adsorption/desorption properties). In the present method according to the invention, the specific size of the active surface can be influenced via the control of the process parameters. The person skilled in the art understands the term specific surface of a body as the quotient of the surface of the body and its mass. As a result of this, it is possible to generate composite particles which have a lower specific active surface than the specific surface of the silicon particles contained in the inside of the composite particles in their initial state. As a result of this, sufficiently small silicon particles can also be used which no longer break during lithium take-up without the comparatively large specific surface (BET measurement) of the small particles in the interior of the composite having a negative effect on the Coulombic efficiency of the battery cell. In one embodiment, the composite material has a specific surface which is no more than twice as large, in particular less than 50% larger, in particular smaller than the specific surface of the silicon particles in the composite material.

One preferred feature of this invention is that the active Si surface of the composite particles which in a battery cell is in exchange with the electrolyte is reduced at least by a factor of 10 in comparison with the case where no carbon coatings are applied around the silicon particles.

The silicon particles used are preferably approximately spherical. In particular, the ratio of the largest diameter to the smallest diameter of a particle is at most 1.5:1, preferably at most 1.3:1 and particularly preferably at most 1.2:1 or at most 1.1:1. This applies in particular to a majority of the particles, i.e. to more than half of the particles or even to more than two-thirds or more than 90% of the particles.

The composite material is generated by mixing silicon particles with a carbon compound (preferably a carbohydrate or in another preferred embodiment a liquid or solid hydrocarbon) and the subsequent controlled thermal conversion or carbonizing of the carbon compound. The term “thermal conversion” refers to the fact that the carbon compound by way of the heat treatment, in particular in step A, undergoes one or more of the following changes: polymerization, change in the mutarotation, inversion, caramelization, oxidation, splitting off of H₂O, splitting off of OH groups, condensation reaction, formation of intramolecular covalent bonds, redistributions, isomerizations, partial pyrolysis, decomposition. The terms heat treatment and temperature treatment are used synonymously. The “transition temperature” is the lowest temperature at which a compound undergoes this conversion under the conditions of the method according to the invention. Depending on the initial composition of the components for the composite material, there are various possible temperature ranges for the selection of the temperature of temperature treatment step A. After the completion of the conversion of the carbon compound in a heat treatment step A, usually with a loss of mass in relation to the carbon compound used, the thermally processed intermediate product is in a different chemical and/or mechanical state for a second thermal treatment step B. This other state also influences the reactivity of the initial components after heat treatment step A in interaction with (other) components in the interior of the systems and tools used for the temperature conversion. The term “carbonization” refers to the fact that the carbon-containing intermediate product generated from the thermal conversion of the carbon compound by way of the heat treatment, in particular in step B, undergoes one or more of the following changes: pyrolysis, splitting off of water vapor, splitting off of OH groups, splitting off of CO, splitting off of CO₂, splitting off of H₂, splitting off of hydrocarbon compounds. It can be advantageous for heat treatment step B that arising or escaping reaction gases from heat treatment step A are discharged and/or actively removed. It is furthermore advantageous if the converted components, i.e. the silicon particles and at least one carbon compound, after heat treatment step A no longer interact with the containers or transport means from heat treatment step A in second heat treatment step B. It can be advantageous to convey the thermally processed intermediate product (after heat treatment step A) into other containers or conveying devices which have different interaction properties for heat treatment step B. In particular, it can be desirable and advantageous that no or only minimal material reactions of the resultant silicon-carbon composite material are performed in heat treatment step B with objects or solid bodies with which the arising silicon-carbon composite material comes into contact during heat treatment step B. It is thus furthermore possible to avoid that arising or escaping reaction gases which are damaging or disadvantageous for these materials precipitate on the walls which enclose or separate off the heated space for thermal conversion or are used for the transport of the material.

Thermogravimetric measurements with downstream mass spectroscopic analysis of the arising or escaping reactions gases can be used to adjust the suitable temperature ranges for heat treatment steps A and B. Moreover, the gas atmosphere can be adjusted in a targeted manner during the method via the studied temperature and heat treatment.

The process temperature in the second heat treatment step of the thermal synthesis process as well as optional processes for generating the desired particle size distribution (milling, de-agglomeration, rolling, breaking, fragmentation, mixing) influence the size of the specific active surface. It is furthermore possible via the selection of the synthesis temperature to reduce any oxides (SiOₓ) present on the surface of the silicon particles carbothermally (e.g. as a result of arising carbon monoxide) or by selecting another reducing atmosphere. Irrespective of whether this is desired, carbides can be generated on the surface of the silicon particles. Evidence of the formation of carbides could be provided by means of XRD in the case of an elevated synthesis temperature of 1300° C. The carbon can optionally also assume the structure of synthetic graphite. A further optional measure of the method according to the invention provides comminuting the intermediate product of the first heat treatment step already prior to the second heat treatment step (also: high-temperature process step) to the defined particle size of the end product (or to a suitable intermediate size). This has advantages when performing the high-temperature process step:
prior to the high-temperature process step, the material is less hard and is easier to grind; this also applies in particular in the case of materials with carbohydrates as a carbon source which tend to form very hard composite particle agglomerates after both heat treatment steps;
as a result of a particle size distribution which can be predefined in the milling process, the subsequent high-temperature process step becomes more reproducible and the choice of suitable production systems for production methods suited to mass production becomes larger; in particular subsequent printing or slotted nozzle coating methods require a suitable starting particle size distribution in the pastes, slurries, hot melt composites or inks to be printed;
in particular when using a rotary furnace, the temperature-time profile can be better and more reproducibly controlled in a through-feed process; it is furthermore possible to avoid by means of the first heat treatment step A (i.e. the conversion) that undesirable splitting-off products concentrate in the gas atmosphere and negatively influence the result of the high-temperature treatment; it can thus also be avoided that residues increasingly accumulate on the inner tube wall of the furnace;
the surfaces of the comminuted particles can be more uniformly and better flushed by flushing/processing gases in the high-temperature process step. Splitting-off products during thermal conversion can be better and more reproducibly extracted and transported away and undesirable secondary reactions with these splitting-off products can be avoided or minimized.

Milling processes after the second heat treatment step could, depending on the method, undesirably form new open silicon surfaces and negatively change the fabric or structure of the Si/C composite particle and as a result impair the function in a battery. This can be suppressed or minimized by suitable comminuting of the Si/C composite material after step A.

When using hydrocarbons as a carbon source, on one hand, an oxidation of silicon in both heat treatment steps can be minimized or suppressed, possibly even existing surface oxides can be removed. Moreover, in the case of suitable selection of hydrocarbons, such as, for example, paraffins, the formation of very hard and larger, compactly adhering particle agglomerates can be avoided. A milling step between first and second temperature treatment is thus no longer necessary. However, it may be necessary to feed the intermediate product in other containers or via a conveying process, for example, into a rotary furnace as bulk material to the second temperature treatment step. In this case, de-agglomeration or comminution of the composite bulk material preferably and automatically occurs when using hydrocarbons as a carbon source and a dispersant.

The method has the following steps.

Mixing silicon particles and at least one carbon compound,
thermal processing of the mixture in at least two steps in the following sequence:
   A. Heat treatment of the mixture at a temperature which corresponds at least to the transition temperature of the carbon compound, in particular the temperature lies in the range from 120° C. to 700° C., preferably 120° C. to 500° C., yet more preferably 120° C. to 350° C., in order to obtain a thermally processed intermediate product;
   B. Heat treatment of the thermally processed intermediate product at a temperature above 750° C. in order to obtain the silicon-carbon composite material. In this case, a carbonization preferably occurs and/or compounds or elements are split off from the intermediate product which can escape and be removed by suction usually in a gaseous form. Increasingly ordered structures are furthermore generated with increasing temperature.

It is vital for the method according to the invention that at least two heat treatment phases are carried out. This means that treatment is performed at at least two different temperatures, which does not necessarily require a cooling between the phases. On the contrary, further heating up can also be performed without significant cooling after first heat treatment phase A in order to perform second heat treatment phase B. The terms “heat treatment phase” and “heat treatment step” are used synonymously herein. It was found that, in the case of gradual heat treatment, initially to a temperature above the transition temperature and thereafter beyond the temperature of the first phase, in the second heat treatment phase, particularly advantageous product properties can be achieved. Moreover, the two heat treatment phases can be performed in separate devices or separate systems and/or containers (e.g. furnaces), which is preferred according to the invention. As a result of this, continuous production methods can be realized. Depending on the material composition of the starting materials and in particular depending on the selection of the carbon compound or the dispersant, it may be advantageous to spatially separate the two heat treatment steps from one another so that different process atmospheres, process pressures and different devices for removal by suction can be used for arising or escaping reaction gases in the two heat treatment steps. The incorporation or transporting of the starting materials can furthermore also be carried out differently in the two heat treatment steps.

In particular when using hydrocarbons such as e.g. paraffin, which can serve simultaneously as a carbon source and as a dispersant, it is advantageous to firstly treat the dispersed silicon particles in the case of a boundary surface which is as large as possible between the dispersed silicon particles and the gas atmosphere in order to easily allow arising or escaping reaction gases to escape. As a result of this, significant gradients in the interaction between the synthesis product and the gas atmosphere are avoided, which in turn ensures largely homogeneous material properties along the height of the container or along the gradients which occur.

A continuous flat transport of the dispersed silicon particles along a temperature gradient, in the case of which the dispersed silicon particles are initially applied as a thin layer onto a transport medium (e.g. onto a continuous conveyor belt), is advantageous because at any time the rapidly arising and escaping reaction gases can be uniformly discharged or extracted or transported away from the heated system where they arise.

At the end of temperature treatment step A, the intermediate product generated in this manner can be collected up again, e.g. as a powder with an already approximately suitable particle size distribution. Collection can be performed, for example, in a vessel which can subsequently be easily channeled into a second process chamber, in which on one hand the higher temperature treatment can be carried out, but which on the other hand can also have completely different process atmosphere compositions, process atmosphere pressures as well as other transport or mounting concepts for the intermediate product which is to be processed further in temperature treatment step B.

In one preferred embodiment, a powder-like intermediate product, with a particle size distribution of 10 µm or less, more preferably 3 µm or less, is initially collected up in a container, from which it, in second temperature step B, is conveyed continuously and in a changed process atmosphere with underpressure or overpressure, relative to the ambient atmosphere, into a high-temperature furnace, such as e.g. a rotary furnace. In this case, the powder-like intermediate product is conveyed continuously along a temperature gradient, preferably by heating up to a higher process temperature, alternatively also cooling. In a further preferred embodiment, based on a rotary furnace, the rotation of the rotary furnace brings about a continuous mixing through of the powder-like intermediate product with simultaneous forward thrust by an adjustable inclination of the rotary kiln. In this case, the rotary kiln is preferably only partially filled, preferably filled to less than 50%, even more preferably to less than 30%, relative to the respective tube diameter along the complete rotary kiln axis. As a result of this, arising or escaping reaction gases can escape rapidly. Moreover, lances in the rotary kiln can be arranged above the product so that different gas feed-in and extraction points are arranged at various points along the thrust motion. As a result of this, it is enabled that arising or escaping reaction gases can already be extracted where they arise and do not only escape at higher temperatures. The material of the rotary kiln should be selected so that the intermediate product does not disadvantageously interact during the second temperature treatment with the rotary kiln with which it comes into contact or even destroys the rotary kiln.

Moreover, the two separate heat treatment phases A and B enable possible intermediate treatments of the thermally processes intermediate product after the first heat treatment phase, such as, for example, milling of the thermally processed intermediate product. It is advantageous if the milling step is allowed to take place in a separate system or apparatus, preferably after cooling.

In preferred embodiments, depending on the starting composition of the synthesis product and/or depending on the carbon compound and/or any further materials in the synthesis, such as, for example, proportions of lithium or lithium-containing compounds, in a case of a controlled atmosphere, controlled temperature control and controlled extraction, the milling step is performed so that the intermediate product remains at all times under these well controlled conditions between temperature treatment A (conversion) and temperature treatment B (high-temperature step) and a controlled or integrated transport is performed between temperature treatment A and temperature treatment B, i.e. in the comminution step (e.g. by milling). In particular, however, a production method with a comparatively small outlay in terms of equipment is possible since preferably neither pressure conditions which deviate significantly from the atmospheric pressure nor process steps which are demanding in terms of equipment, such as e.g. spray drying, are necessary.

In one embodiment, at least step B, optionally also step A, is performed in a substantially oxygen-free atmosphere, in particular in a process gas atmosphere with less than 100 ppmv, less than 10 ppmv or less than 1 ppmv or less than 0.1 ppmv O₂. The atmosphere can be an inert gas atmosphere, in particular a nitrogen or noble gas atmosphere. However, other atmospheres are also possible, such as reducing atmospheres, for example, with hydrogen and/or carbon monoxide. Reducing atmospheres have the advantage of being able to reduce silicon oxides or reducing the oxidation. Silicon very rapidly forms an SiO₂ layer on the silicon surface upon contact with air in particular at higher process temperatures. In one embodiment, this SiO₂ layer is reduced in size or is only very thin and in particular is substantially not present. A low-oxygen atmosphere can be used as an alternative to the substantially oxygen-free atmosphere, in particular with an O₂ proportion of less than 5 vol-% or less than 1 vol-%. Alternatively or additionally to the low-oxygen or substantially oxygen-free atmosphere, process liquid can be used which can prevent the silicon from coming into contact with the air. In one preferred embodiment, a hydrocarbon-based process liquid, such as, for example, paraffin or paraffin oil, is added to the mixture of silicon particles and at least one carbon compound in order to minimize or entirely avoid contact of the dispersed solids content with air and/or oxygen and/or nitrogen and/or humidity and/or other undesirable gases, e.g. also arising or escaping reaction gases. In this case, the process liquid wets the solid components of the dispersion and only escapes in the case of an elevated temperature or changed process atmosphere during temperature treatment step A (conversion process), preferably, however, only completely during temperature treatment step B. In a more preferred embodiment, the mixing of the silicon particles with the carbon compound and possibly other synthesis starting materials is performed in the low-oxygen or substantially oxygen-free atmosphere and/or in the process liquid itself.

Preferred atmospheres comprise or are composed of nitrogen, carbon dioxide, carbon monoxide, hydrogen, noble gases such as, for example, argon or helium, or mixtures thereof. Preferred process liquids are liquids which are suitable for keeping atmospheric oxygen away from the silicon surface. Substances are particularly suitable which are liquid at room temperature (20° C.) and/or in which the carbon compound has a solubility at 20° C. of at least 1 g/L, in particular at least 10 g/L or at least 50 g/L. Suitable liquids are liquid at room temperature and atmospheric pressure and wet silicon and/or silicon oxide surfaces. In one embodiment, the liquid can be mixed with water, i.e. such that it forms a single liquid phase with water at room temperature. Preferred liquids dissolve the carbon compound in the mixture, in particular completely. Preferred process liquids are water, monovalent or multivalent alcohols, e.g. isopropanol or ethanol, in particular bivalent alcohols, such as e.g. ethylene glycol, or mixtures thereof. Particularly preferred process liquids are based on paraffin. Process liquids are preferably used which have an evaporation temperature above the transition temperature of the carbon compound. For example, correspondingly selected liquid hydrocarbons are used if carbohydrates, such as e.g. saccharides, form the main carbon source. The process liquids preferably lead to good wetting of the silicon particles with the carbon compound or the converted carbon compound. Since water facilitates the oxidation of silicon, in one preferred embodiment, no water is used. The person skilled in the art is able to select suitable process liquids. In one embodiment, the mixture is produced without adding liquid. The mixture then comprises silicon and at least one carbon compound, for example, hydrocarbons such as paraffin, toluene or the like. In one embodiment, a dispersant is used which is not or is not fully evaporated at the end of the first heat treatment step (step A). If the dispersant is not fully evaporated, a comminution of the thermally processed intermediate product can be performed with a low degree of outlay, and in the case of paraffin or other suitable hydrocarbons furthermore with the exclusion of atmospheric effects.

In one alternative preferred embodiment, a paraffin is used as a process liquid, which is solid at room temperature and becomes liquid at moderate temperatures, preferably from 30° C. to 90° C., and serves to disperse the components precisely at these temperatures, in order to solidify again after dispersion, preferably with the exclusive of oxygen. As a result of this, for example, lithium or lithium-containing starting materials can be included in the dispersion without reacting with oxygen, nitrogen and/or water vapor or air humidity. After cooling and solidification of the dispersion, this can also be transported on air, and indeed avoiding the risk or interactions of the atmosphere with the lithium-containing compounds. In particular, the highly exothermal reactions, with the potential consequence of fire, of lithium or lithium-containing starting materials can thus be suppressed and avoided.

In one preferred embodiment, after the first heat treatment step, at least 10 wt.-%, in particular at least 20 wt.-% of the dispersant used is still present. Dispersants with a boiling point above 120° C., in particular above 150° C. or above 160° C. or above 180° C. at normal pressure are preferred. Process liquid and dispersant can be identical or different. In one embodiment, after the conclusion of step A, at least 90 wt. -%, in particular at least 95 wt.-% or at least 99 wt.-% of the dispersant and/or the process liquid are no longer contained in the intermediate product, in particular are evaporated or reacted away.

The cooling after step B and/or after step A is also preferably performed in a low-oxygen or substantially oxygen-free atmosphere, such as e.g. an inert gas atmosphere, in particular a nitrogen or noble gas atmosphere or reducing atmosphere. A further preferred embodiment uses a reducing atmosphere (hydrogen or carbon monoxide content).

In one embodiment, at least one additive is added to the mixture. Suitable additives comprise structure-giving and/or catalytically acting additives, in particular selected from graphene, graphene oxide, graphite, fullerenes, nanotubes and combinations thereof. Suitable catalytically acting additives can alternatively or additionally be selected, for example, from different iron compounds or contain other catalytic additives known to the person skilled in the art. These additives can be present in the mixture in a proportion of 0.01 to 10.0 wt.-%, in particular of 0.05 to 5.0 wt.-% or 0.1 to 2.5 wt.-%. In the case of addition of these additives, the duration of the first and/or second heat treatment step and/or the temperature of the first and/or second heat treatment step can be reduced. The method can also be performed without additives.

In one preferred embodiment, the mixture of the starting materials can contain the following components:

| | |
|---|---|
| Silicon | 1.5 to 99.0 wt.-% |
| Carbon compound | 1.0 to 50.0 wt.-% |
| Dispersant | 0.0 to 90.0 wt.-% |
| Additive | 0.0 to 10.0 wt.-% |

In one embodiment, a dispersant is used in the mixture and the mixture contains the following components:

| | |
|---|---|
| Silicon | 1.5 to 35.0 wt.-% |
| Carbon compound | 15.0 to 50.0 wt.-% |
| Dispersant | 30.0 to 83.5 wt.-% |
| Additive | 0.0 to 10.0 wt.-% |

In a further embodiment of the mixture which contains dispersant, this mixture contains the following components:

| | |
|---|---|
| Silicon | 5.0 to 35.0 wt.-% |
| Carbon compound | 15.0 to 40.0 wt.-% |
| Dispersant | 40.0 to 70.0 wt.-% |
| Additive | 0.0 to 5.0 wt.-% |

In one alternative embodiment, a dispersant is not used at all or only in very small quantities in the mixture and the mixture contains the following components:

| | |
|---|---|
| Silicon | 50.0 to 90.0 wt.-% |
| Carbon compound | 10.0 to 50.0 wt.-% |
| Dispersant | 0.0 to 5.0 wt.-% |
| Additive | 0.0 to 10.0 wt.-% |

In a further embodiment of the mixture with a low level of dispersant or which is free from dispersant, this mixture contains the following components:

| | |
|---|---|
| Silicon | 60.0 to 90.0 wt.-% |
| Carbon compound | 10.0 to 40.0 wt.-% |
| Dispersant | 0.0 to 2.0 wt.-% |
| Additive | 0.0 to 5.0 wt.-% |

In one alternative embodiment, a dispersant is not used at all or only in very small quantities in the mixture and the mixture contains the following components:

| | |
|---|---|
| Silicon | 50.0 to 70.0 wt.-% |
| Carbon compound | 30.0 to 50.0 wt.-% |
| Dispersant | 0.0 to 5.0 wt.-% |
| Additive | 0.0 to 10.0 wt.-% |

In a further embodiment of the mixture with a low level of dispersant or which is free from dispersant, this mixture contains the following components:

| | |
|---|---|
| Silicon | 60.0 to 70.0 wt.-% |
| Carbon compound | 30.0 to 40.0 wt.-% |
| Dispersant | 0.0 to 2.0 wt.-% |
| Additive | 0.0 to 5.0 wt.-% |

In a further embodiment of the mixture with a low level of dispersant or which is free from dispersant, this mixture contains the following components:

| | |
|---|---|
| Silicon | 70.0 to 90.0 wt.-% |
| Carbon compound | 10.0 to 30.0 wt.-% |
| Dispersant | 0.0 to 2.0 wt.-% |
| Additive | 0.0 to 5.0 wt.-% |

In one alternative embodiment, there is used in the mixture an alternative liquid or solid carbon compound from the category hydrocarbons, in particular paraffins, which can also serve simultaneously as a dispersant at room temperature or at least at slightly elevated temperatures:

| | |
|---|---|
| Silicon | 50.0 to 99.0 wt.-% |
| Carbon compound = Dispersant | 1.0 to 50.0 wt.-% |

In one preferred embodiment of the stated alternative embodiment, the mixture of the starting materials can contain the following components, wherein paraffin is used as a carbon compound and dispersant:

| | |
|---|---|
| Silicon | 9.0 to 33.0 wt.-% |
| Carbon compound = Paraffin | 67.0 to 91.0 wt.-% |

In a further preferred embodiment of the stated alternative embodiment, the mixture of the starting materials can also contain saccharose in addition to silicon and paraffin:

| | |
|---|---|
| Silicon | 9.0 to 33.0 wt.-% |
| Paraffin | 67.0 to 91.0 wt.-% |
| Saccharose | 0.9 to 33.0 wt.-% |

In a further preferred embodiment of the stated alternative embodiment, the mixture of the starting materials can also contain a suitable lithium compound in addition to silicon and paraffin, wherein the material quantity ratio of the atoms of Si to Li lies between 1:0.5 and 1:5.0.

| | |
|---|---|
| Silicon | 9.0 to 33.0 wt.-% |
| Paraffin | 67.0 bis 91.0 wt.-% |

The mixtures used have a comparatively high proportion of solids in comparison with the prior art. This refers to the proportion which remains as a solid in the event of evaporation of the dispersant and/or the process liquid. This is in particular the sum of the proportions of silicon, carbon compound and optional additive. This proportion of solids can be at least 9.0 wt.-%, at least 16.5 wt.-% or at least 20.0 wt.-% in relation to the mass of the mixture. The proportion of solids can be still significantly higher in the variants with a low degree of dispersant or which are free of dispersant. In the mixtures which contain dispersant, the proportion of solids is preferably up to 70.0 wt.-% or up to 60.0 wt.-%. In one preferred embodiment, the proportion of solids is even up to 90 wt.-%. In the case of an excessive proportion of solids, it is more difficult to achieve a homogeneous distribution of the carbon compound on the silicon. If in turn the proportion of dispersant is too high, too much time and energy is required to remove the dispersant. Moreover, a high proportion of dispersant should be avoided in terms of costs and potentially environmentally damaging emissions which should be minimized. There is furthermore the risk in this case that the silicon particles oxidize further on their surface. Since the method is not reliant on the use of spray drying, relatively high proportions of solids can be realized which reduces the energy requirement and equipment outlay as well as the use of solvents. The mixture is therefore preferably not spray-dried, in particular the entire production method manages without spray drying and uses highly viscous dispersions which are entirely unsuitable for spray drying. In this case, the proportion of dispersant is reduced to such an extent that a dispersion of the starting raw materials is still easily possible, but arising or escaping reaction gases can escape, while simultaneously minimizing the costs for dispersant and any after-treatment.

Since the dispersant also serves to ensure as homogeneous as possible distribution of the carbon compound on the silicon, the ratio of these two components is important. A mass ratio of carbon compound to dispersant in the range from 0.1 to 0.7, in particular in the range from 0.1 to 0.4 or from 0.3 to 0.7 can be used. These ratios have been shown to be expedient. In one embodiment, the objective is to keep the proportion of dispersant as low as possible in order to be able to still achieve sufficiently homogeneous dispersal. In one preferred embodiment, in this case, very high viscosities of the mixture of greater than 5000 mPa·s, in particular greater than 15000 mPa·s or greater than 25000 mPa·s are desirable for the purpose of dispersal. In one embodiment, the viscosity is not above 50000 mPa·s. In particular, the viscosity reduces with increasing shear rate (shear thinning properties). Small quantities of dispersant have a positive effect on the costs of the method, the environmental friendliness of the method as well as avoiding undesirable parasitic oxidation of the particles during the outgassing of oxygen-containing elimination or outgassing products of the dispersant during the thermal treatment phases.

The viscosity can be determined e.g. with a rotational viscometer (plate/plate with 0.3 mm gap width, opposite rotation, shear rate 100/s) at 21.5° C.

It was found that the silicon-carbon composite material has, in the case of use as or in an anode material for lithium-ion batteries, outstanding properties, in particular in terms of the efficiency in the first operating cycle (first cycle efficiency) and also in terms of the non-toxic and environmentally friendly binding agents and solvents which can be used. In one embodiment, this advantage is potentially associated with the fact that the silicon has substantially no or only a thin layer of silicon dioxide in the region of the boundary surface with the carbon.

In XPS measurements (X-ray photoelectron spectroscopy), it was shown that no silicon carbide is located on the surface (FIG. 10). The XPS results furthermore indicate that the SiO₂ particles on the surface are functionalized with graphite, wherein the SiO₂ particles on the surface are, however, not fully functionalized with graphite. This finding is associated with the fact that the graphite layer is with high probability less than 3 nm thick so that specific regions of the Si surfaces which were originally oxidized and still have thin oxide layers are detected.

The formation of lithium silicate, which has poor diffusion properties for Li⁺ ions, when using the material in the battery cell, is potentially suppressed by the reduction in the amount of SiO₂ in this region. Moreover, one particular achievement of this invention is to provide such a simple method for the silicon-carbon composite material.

The silicon which is used as a starting material involves silicon particles. Porous or porosified silicon particles known per se to the person skilled in the art are also possible as silicon particles. The silicon can be amorphous or crystalline silicon, in particular polycrystalline silicon. The silicon can be used in particle sizes D90 of less than 300 nm or less than 200 nm.

Silicon which has at least one partial surface composed of silicon dioxide can be used as a starting material of the method. In particular silicon particles are considered, on the surface of which an oxide layer has formed as a result of contact with an oxidizing environment. The method optionally comprises a step of removing silicon dioxide from the surface of the silicon. This can occur, for example, by means of milling, plasma treatment and/or etching. Alternatively or additionally, a reducing atmosphere can be used for this purpose.

The etching for removal of the silicon dioxide preferably takes place using an acid or base. Preferred substances are HF, KOH, NH₄F, NH₄HF₂, LiPF₆, H₃PO₄, XeF₂, SF₆ and mixtures thereof. HF is particularly preferred. The acid or base can be mixed with structure-giving or catalytically acting additives (e.g. metal assisted etching). In one embodiment, a plasma treatment is used to remove the oxide layer. In one embodiment, the etching is used during the heat treatment, in particular during step A.

The silicon preferably used here is elementary silicon, in particular in the form of silicon particles. Silicon particles can optionally have further substances, in particular other metals, oxides, carbides or doping agents (in particular phosphorus, boron, gallium or aluminum which increase the conductivity of the silicon), preferably at most in small quantities such as < 10 wt.-% and particularly preferably <1.0 wt.-%. In one embodiment, the silicon particles are composed of elementary silicon, a silicon oxide or a binary, ternary or multinary silicon/metal alloy (with, for example, Li, Na, K, Sn, Ca, Co, Ni, Cu, Cr, Ti, Al, Fe). In one preferred embodiment, SiₓLi_{y} particles alloyed with lithium can be produced from Si particles at comparatively low temperatures, preferably with the exclusion of oxygen, nitrogen and water vapor, for example, in a paraffin dispersion. The SiₓLi_{y} particles are preferably generated during temperature treatment step A. In this case, an Li proportion of up to 35 wt.-% relative to the SiₓLi_{y} alloy is preferred, even more preferably between 10 and 30 wt.-%.

The silicon preferably has at most a small proportion of contaminants, in particular less than 10 wt.-% and particularly advantageously less than 1.0 wt.-% contaminants (such as B, P, As, Ga, Fe, Al, Ca, Cu, Zr, C). Phosphorus, boron, aluminum, tin, antimony and/or gallium can be added with the aim of improving the conductivity of the Si particles. In one preferred embodiment, the silicon has typical doping agent concentrations in the range from 10¹⁵ to 10²¹ doping agent atoms per cm³. For certain applications, it is advantageous to dope the silicon. In one preferred embodiment of the method, a corresponding doping agent proportion is added to the mixture of silicon particles and at least one carbon compound already during temperature treatment A or alternatively during temperature treatment B. In terms of an economical method, the addition of aluminum is particularly advantageous since Al-doped Si particles can be generated at temperatures above 577° C., i.e. the eutectic temperature, or above 660° C., the melting point of Al.

If the silicon particles contain a silicon oxide, the stoichiometry of the oxide SiOₓ then preferably lies in the range 0 < x < 1.3. If the silicon particles contain a silicon oxide with a higher stoichiometry (such as, for example, x=2), its layer thickness on the surface is then preferably smaller than 10 nm.

In the case of an alloy of the silicon particles with a metal M (e.g. an alkali metal), the stoichiometry of the alloy M_{y}Si can lie in the range 0 < y < 5. The silicon particles can be alloyed with lithium. In this case, the stoichiometry of the alloy Li_{z}Si is preferably in the range 0 < z < 2.2. In another preferred embodiment, however, Li_{z}Si alloys in the range 2 < z < 4.3 are used.

The alloying of silicon and lithium can, in one preferred embodiment, also first be performed during temperature treatment steps A or B. One key thing to note here is the form in which the lithium source is added prior to the respective temperature treatment steps of the synthesis and how the lithium source interacts with the respective process atmosphere or the dispersant or other synthesis components. If, for example, pure lithium is added to the synthesis or the dispersion, it should be strictly ensured that lithium does not react with oxygen, nitrogen or even water vapor. This can, for example, be avoided by virtue of the fact that lithium is wetted and handled with paraffin oil as a dispersant. Additionally or alternatively, at least step B, optionally also step A, is performed in a substantially oxygen-free, nitrogen-free and water vapor-free atmosphere, or in an atmosphere with less than 100 ppmv, preferably less than 10 ppmv, preferably less than 1 ppmv or less than 0.1 ppmv of in each case O₂, N₂ or H₂O.

In order to achieve, after the temperature treatment of steps A and B, alloy particle sizes in the micrometer range or sub-micrometer range, at least one of the alloying partners should be present in a finely dispersed manner and with small particle sizes in the initial state, i.e. prior to the temperature treatment, ideally both alloy starting materials. Depending on the melting point of the lithium source and depending on the dispersant used, it can be advantageous to initially perform the carbon coating of the silicon particles in temperature treatment step A and only add the lithium source in temperature treatment step B. Very many lithium starting materials are possible as a lithium source for such alloy syntheses. In addition to lithium itself, lithium salts, e.g. lithium halogenides, in particular lithium bromide, lithium hydrides, lithium hexafluorophosphate, lithium stearate, lithium nitride, lithium amide, lithium carbide and lithium soaps, are particularly suitable.

In one preferred embodiment, the silicon particles are composed by at least 90 wt.-% (in particular ferrosilicon), preferably at least 95 wt.-%, preferably 98 wt.-% of silicon (in particular of metallurgic silicon), relative to the total weight of the silicon particles. The silicon particles preferably contain substantially no carbon.

In one embodiment, the silicon particles can have on the surface Si—OH— or Si—H— groups or covalently bonded organic groups, such as, for example, alcohols or alkenes. The wetting properties of the liquid components, e.g. dispersant or liquid carbon compound, can thus be influenced in a targeted manner during the synthesis.

It is furthermore possible and advantageous under certain circumstances to apply in a targeted manner a coating with methods such as ALD (atomic layer deposition), PVD (sputtering, evaporation deposition), CVD (chemical vapour deposition) or PECVD (plasma enhanced CVD) in order to inhibit the formation of solid-electrolyte boundary layers and/or improve the lithium transport properties. The coating can comprise, among other things, aluminum oxide, titanium oxide, zirconium oxide, silicon carbide and/or other carbon-containing (also organic) coatings or Li-containing coatings. Such coatings are possible both prior to and after the thermal treatment steps or the last step for adjustment of the particle size distribution and even on anode surface after their completion. In the case of powder-type particles, a fluidized bed ALD method is preferred, in the case of which the escape of particles is minimized by a suitable construction of the fluidized bed reactors.

Moreover, Li-containing components or lithium itself, particles or liquids can be added to the mixture or the intermediate product prior to step A and/or step B with the aim of allowing lithium-silicon alloys to be produced during the temperature treatment. Suitable components can be selected from the group comprising Li salts such as, for example, LiF, LiCl, LiBr, LiI, Li₃N, LiNH₂, LiPF₆, or Li₂CO₃; lithium hydrides such as, for example, LiH, LiBH₄, LiA1H₄; organic lithium compounds such as, for example, n-butyl lithium, tert-butyl lithium, methyl lithium and phenyl lithium, lithium diisopropylamide, lithium-bis(trimethylsilyl)amide; lithium soaps and combinations thereof. In particular, in one embodiment, Li-containing components can also only be added at the end of the second temperature treatment step B or thereafter to the composite material produced prior to a third temperature treatment. This requires good control of the gas atmosphere, in particular a substantially oxygen-free, nitrogen-free and water- or water vapor-free atmosphere, during and after the first two temperature treatment steps A and B, and a potential further temperature treatment step.

The lithium-containing synthesis particles coated with carbon should furthermore potentially be protected from undesirable reactions with the atmosphere or binders after the temperature treatment. This can be realized by further processing and/or storage in a protective atmosphere or inert gas atmosphere, in a vacuum or in a dispersion with a suitable liquid or a binder, which suppresses undesirable reactions.

In one embodiment, the method of this invention presents a possibility of producing a silicon-carbon composite material which, between silicon and carbon, has a layer of silicon dioxide (SiO₂) with a reduced thickness. The silicon particles can optionally be pretreated in HF or another fluorine compound to remove silicon oxides before the mixture with the carbon compound is produced. The silicon particles can subsequently be mixed directly with a liquid carbon compound, such as paraffin, or a dispersant in order for them to undergo heat treatment. This method can be performed with the exclusion of air, in a low-oxygen or substantially oxygen-free atmosphere. In one preferred embodiment, the silicon particles are moved into a hydrofluoric acid (HF) dispersion prior to mixing with at least one carbon compound and prior to thermal processing of the mixture in order to remove the oxide on its surface, and subsequently transferred into a dispersion with liquid paraffin in a suitable vessel. As expected, complete phase separation occurs between HF and the silicon particles dispersed in paraffin. The HF can subsequently be separated off e.g. via filters.

The carbon compound is suitable for forming a carbon-containing coating on the surface of the silicon, in particular a coating which contains structured carbon or is even composed thereof. The compounds are characterized in that they, during the heat treatment described herein, form carbon, in particular at least partially structured carbon. Preferred carbon compounds in the context of the present invention are carbohydrates, in particular saccharides, as well as mixtures of different carbohydrates or hydrocarbon compounds which are solid or liquid at room temperature. In preferred embodiment, the carbon compound is selected from monosaccharides, disaccharides and polysaccharides as well as mixtures thereof. Preferred saccharides, which are used in the context of this invention as a carbon compound, are glucose, fructose, galactose, saccharose, maltose, lactose, starch, cellulose, glycogen or mixtures or polymers thereof.

Other biopolymers, such as lignin, can alternatively or additionally be used as a carbon compound so that crude oil-based products can be largely avoided. The carbon compound is preferably not a polymeric plastic. Regenerative raw materials which are available in the desired/necessary quantity at low material costs without causing environmental damage are preferably selected as a carbon compound. For example, carbon compounds are accordingly preferably selected from the list of waxes, plant oils, fats, oils, fatty acids, rubber and resins.

In one preferred embodiment of the method, the carbon compound alternatively or additionally comprises at least one carbon compound selected from the list of lignin, waxes, plant oils, fats, oils, fatty acids, rubber and resins. This is advantageous in terms of biocompatibility to avoid environmental damage and minimize environmental impact.

In another preferred embodiment, the carbon compound is paraffin or a related hydrocarbon. The combination of silicon particles with paraffin as a carbon compound is advantageous because it enables a significant shortening and simplification of the process, namely a milling step is no longer necessary as an intermediate step.

The term “structured carbon” is known to the person skilled in the art. The term comprises in particular graphene, graphene oxide, carbon nanotubes, fullerenes, aerographite, “hard carbon” and graphite.

The quantity of carbon compound is preferably selected so that a mass ratio of carbon to silicon between 3:1 and 1:90, in particular between 3:1 and 1:20, more preferably between 1.2:1 and 1:10 and particularly preferably approximately 1:5 or approximately 1:9, is produced in the composite material. The coating on the silicon preferably comprises more than one carbon layer, in particular at least 2 carbon layers, at least 3 carbon layers or at least 5 carbon layers. According to the invention, the stated mass ratio is preferably achieved in that the mass proportion of the carbon compound in the mixture is either between 5% and 110% of the mass of the silicon, or between 1000% and 200% of the mass of the silicon. In preferred embodiments, the stated mass proportion in the mixture is between 25% and 80%, in particular between 35% and 70% and particularly preferably between 40% and 60% relative to the mass of the silicon. The selection of the suitable quantity of carbon compound contributes to obtaining the desired configuration of the silicon-carbon composite material.

In preferred embodiments in which liquid hydrocarbons, such as e.g. paraffin, are used as a single carbon source and simultaneously as a dispersant, the mass proportion of the carbon compound in the mixture is between 1000% and 100% of the mass of the silicon. For example, 15 ml paraffin is mixed with 3 g Si. The indicated range of the liquid hydrocarbons is necessary to ensure a good dispersion with the silicon particles, but also because a high proportion of the liquid hydrocarbons escapes during thermal treatment. The proportion of the carbon source is preferably selected so that the proportion is just sufficient to be able to easily disperse the silicon particles therein. Here, further materials can also be added to the mixture. When using hydrocarbons such as paraffin, this can, among other things, also be compounds which contain lithium or elementary lithium since, as a result of the use of paraffin, air is excluded during mixing and dispersion and undesirable reactions of the lithium compound with nitrogen, oxygen and/or air humidity or water vapor can be avoided.

In one preferred embodiment in which paraffin is used as a single carbon source and simultaneously as a dispersant, the mass ratio of paraffin to silicon is in the range 1:1 to 10:1, and preferably in the range 3:1 to 6:1. After thermal treatment steps A and B, silicon-carbon composite materials are generated in which the silicon mass proportion is normally more than 80%, preferably more than 90%, more preferably more than 95% and most preferably more than 99%. In a further preferred embodiment in which lithium compounds or lithium are additionally used in the starting synthesis, their proportion is normally selected so that the composite material after the synthesis contains atomic ratios of Li to Si of 0.5:1 to 4:1, preferably 1:1 to 3:1. The use of hydrocarbons, such as e.g. paraffin, as a carbon source and simultaneous dispersant is advantageous because a separation of the thermal treatment into two separate temperature treatment steps A and B with interim cooling and a milling process after the first temperature treatment can be dispensed with. The two temperature treatment steps A and B only have to be separated spatially and/or chronologically in order to conduct away the arising and escaping substances separately during heat treatment process A without disadvantageously influencing the gas atmosphere of second heat treatment step B. A further advantage is that the treatment times in the case of the separate heat treatment steps can be significantly shortened.

In other preferred embodiments in which both carbohydrates (such as e.g. saccharose) and paraffin - the latter as a dispersant and as a carbon source - are used while excluding air in order to produce the silicon-carbon composite material, a suitable small quantity of paraffin is added for the purpose of dispersion so that the viscous dispersion can disperse. Such a viscous dispersion is not suitable for spraying methods.

In one preferred embodiment, the step of mixing comprises bringing a silicon surface or silicon oxide surface into contact with the carbon compound. The mixing can comprise a dispersing of the silicon particles in the dispersant/process liquid. In particular, the step comprises the production of a dispersion, the carbon compound, the silicon and the dispersant. In this case, the silicon is brought into contact with the dispersion in particular by incorporating the silicon into the dispersant or by application of the dispersion onto the silicon. The incorporation of the silicon into the dispersant can be performed together with the carbon compound, before it or after it. In this preferred configuration of the method according to the invention, a dispersion is therefore present which comprises, in addition to the dispersant, the carbon compound and the silicon. The silicon can in particular be a plurality of silicon particles. This makes a particularly simple and cost-effective method possible. In one preferred embodiment, the carbon compound is dissolved in the dispersant and additives such as structured carbon as well as the silicon particles are dispersed therein. In one configuration of the method, the bringing into contact takes place before the optional step of milling the mixture, wherein the dispersant can preferably serve during milling as a milling medium and protective fluid.

The use of the dispersions which have just been described has the advantage that a silicon surface is protected by the dispersant from the influence of atmospheric oxygen and other oxidizing ambient influences. The dispersant preferably serves in this context as a protective fluid. The dispersant furthermore ensures an even distribution of the carbon compound on the silicon. In one preferred configuration, the dispersant is in heat treatment step A partially or entirely removed and the carbon compound precipitates on the silicon surface and is at least partially converted. A heat treatment step B can subsequently be advantageously performed as also described above in order to convert the carbon compound which is now precipitated on the silicon surface into a carbon-containing coating. In particular, the carbon compound is converted in such a manner that other elementary components apart from carbon and silicon, and if a lithium source is used in the starting compounds also apart from lithium, are largely removed from the arising composite and where possible structured carbon compounds are formed in close contact around the surfaces of the silicon particles, or if a lithium source is present in the starting compounds is a similarly structured Si—Li—C alloy. The term “substantially removed” can be understood in particular such that the proportion of components in the composite, which are not carbon or silicon, and possibly lithium, is at most 15 wt.-%, at most 10.0 wt.-%, at most 5.0 wt.-%, at most 3.0 wt.-% or at most 1.0 wt.-%.

The silicon can advantageously be a body or a particle or a majority of particles, the surface of which is at least partially, in particular by at least 90% or at least 95%, in particular substantially completely, composed of silicon and/or silicon oxide. The body or the particle(s) is/are preferably composed of silicon.

The silicon can have in particular a particle size D90 of less than 500 nm or less than 300 nm. In one embodiment, the particle size D90 is at least 50 nm. The particle size can be determined, for example, by means of dynamic light diffusion or by means of REM. In the case of spherical particles, the particle size corresponds to the diameter of the particle. In this case, the value D90 describes the point in the particle size distribution at which 90% of the particles have a smaller particle size than D90 or an identical particle size. Other D values should be understood in an analogous manner. If the D value relates to the mass distribution, D90 means that 90% of the entire particle mass is composed of particles which are smaller than or equal to the D90 value. Other D values should also be understood analogously here. Unless indicated otherwise herein, the D value relates to the distribution of the number of particles.

### Heat Treatment

The temperature in step A lies above the transition temperature of the carbon compound, in particular at least 5° C., at least 10° C. or at least 20° C. above the transition temperature of the carbon compound. If a mixture of different compounds is used as a carbon compound, the temperature lies in particular above the transition temperature of that compound with the highest transition temperature. In particular, the temperature in step A lies above the temperature in step B. The temperature in step A can be from 120° C. to 700° C., preferably 120° C. to 500° C., even more preferably from 120° C. to 350° C., it can lie in the range from 150° C. to 250° C. In one embodiment, the temperature lies in step A at 175° C. to 200° C. and/or above 180° C. The temperature during the heat treatment does not have to be constant in the case of a specific temperature, but can also assume other values or vary around a set value temporarily, on a planned basis or as a result of technically induced deviations. In the context of this invention, however, the heat treatment provides for at least a certain period of time, in particular the time described herein, that the mixture in step A is exposed to a temperature within the stated limits. This can be performed, for example, in a furnace. It is not ruled out that a heat treatment according to step A initially comprises a treatment for a first period of time in the indicated temperature conditions and subsequently for a second period of time as long as it is ensured that the temperatures and times stated herein are satisfied overall. It is nevertheless preferred that the heat treatment according to step A takes place in one step, i.e. without the minimum temperature being undershot during step A.

The heat treatment according to step A is preferably performed at a pressure of 95 to 110 kPa, in particular at atmospheric pressure. In one alternative embodiment, the step can be performed at elevated pressure, in particular in the case of overpressure of more than 5 Pa, in particular more than 5 kPa or more than 15 kPa, in comparison with the ambient pressure. Overpressure can help to keep the ambient atmosphere out of the furnace used if operation is in a low-oxygen or substantially oxygen-free atmosphere. An elevated pressure can also have an influence on enthalpy so that elevated pressure can save energy. In this embodiment, an overpressure of 10-1000 kPa in comparison with the ambient pressure is desired. In a further embodiment, step A is performed in the form of a hydrothermal carbonization. In this case, particularly high process pressures in particular higher than 0.5 MPa are used. The energy requirement for process step A can be reduced in the case of suitable process management.

In another preferred embodiment, an underpressure in comparison with the ambient atmosphere or even a vacuum is desired. This requires the hermetic sealing off of the furnace interior from the ambient atmosphere and has the advantages that the process atmosphere in the interior of the furnace can be kept largely oxygen-free or low-oxygen even in the event of outgassings during the conversion, decomposition or carbonization processes. Outgassing products which split off from the original carbon compounds are as a result of this immediately extracted and discharged to the atmosphere surrounding the process material. Typical pressures preferably extend absolutely from 0.01 to 95 kPa. In one embodiment, the underpressure is at least -5 kPa or at least -15 kPa in comparison with the ambient pressure. The use of the underpressure can optionally also replace the effect of the protective atmosphere.

In one embodiment, the indicated temperature in step A is maintained for a period of at least 1 minute or at least 5 minutes, in particular of 5 minutes to 1000 minutes. Heat treatment step A is preferably performed for a duration of at least 15 minutes, in particular at least 25 minutes, or at least 1 hour, or at least 2 hours and particularly preferably at least 5 hours or at least 12 hours. A minimum duration is recommended to ensure a partial or complete removal of liquids or a substantial conversion of the carbon compound. Heat treatment step A can be terminated after the conclusion of these processes. According to the invention, this is preferably at the latest after 20 hours, in particular at the latest after 10 hours and preferably at the latest after 6 hours or after at the latest 2 hours.

The heat treatment according to step A serves to prepare the thermal decomposition of the carbon compound. In particular, during a corresponding heat treatment, a potentially present solvent, possibly the dispersant, milling medium and/or process liquid evaporates partially or completely and a carbohydrate used as the carbon compound or an alternatively or additionally used carbon compound is at least partially converted. Since significant local differences in the loading of the process atmosphere with the escaping substances can arise during conversion of the carbon source and/or the escape of the solvents or dispersants, it should be ensured that these substances are suitably discharged from the furnace interior or interior of the temperature treatment system and condensation of the discharged reaction gases is prevented in the outgoing air flows as a result of colder surfaces and from dropping or running back into the interior of the thermal system. A forming condensate is furthermore prevented from blocking or destroying the outgoing air channels.

In one preferred embodiment of the method, relating to the dispersed (starting) mixture of silicon particles and at least one carbon compound, the method comprises the immediate subsequent step of full-surface and/or thin application of the mixture onto a conveyor belt or another suitable transport medium. This has the advantage that reaction gases which escape during subsequent thermal processing of the mixture travel rapidly into the process atmosphere and large quantities of the (starting) mixture do not flow through first. In a further preferred embodiment of the method, the method comprises the additional step of transporting the mixture during the thermal processing, in particular by one or more heat treatment systems. As a result of this, it is e.g. possible to locally extract reaction gases which escape along the temperature-time profile of the heat treatment A in a spatially separated manner and in a manner independent of the arising temperature so that in the case of subsequent higher temperatures a different atmosphere composition is present than was the case with the lower temperatures previously spatially passed through. This is particularly advantageous if water vapor or oxygen compounds are generated since these are (can be) extracted in the case of comparatively lower temperatures and these can then no longer lead to a possible oxidation of silicon or lithium at high temperatures.

The temperature in step B lies in the range from >750° C. to 2600° C. In particular, the temperature in step B lies above the temperature in step A. In one embodiment, the temperature in step B is limited to at most 2000° C. or at most 1800° C. or at most 1400° C. The temperature in step B can be at least 800° C., at least 1000° C., >1000° C. or at least 1050° C. In one embodiment, the temperature is from 1000° C. to 1600° C., it can lie in the range from 1050° C. to 1500° C. The temperature can go to below the melting point of the silicon particle, in particular below the melting point of pure silicon. The temperature during the heat treatment does not have to be constant at a specific temperature, but can also assume other values or vary around a set value temporarily, on a planned basis or as a result of technically induced deviations. In the context of the invention, the heat treatment nevertheless provides for at least a certain time, in particular the time described herein, that the thermally processed intermediate product in step B is exposed to an ambient temperature within the stated limits. In one preferred embodiment, the temperature in step B is from 800° C. to 1200° C., more preferably from 800° C. to 1100° C. In one particularly preferred embodiment, the temperature in step B is adjusted so that substantially no silicon carbide formation takes place. This is particularly advantageous if paraffin or paraffin oil is used as a carbon source.

The heat treatment can optionally be performed with a heating rate selected in a targeted manner to the target temperature desired in the respective step in order to allow, for example, volatile components to initially escape before the target temperature is reached. Preferred average heating ramps lie between 1 K/min and 100 K/min, preferably between 2 K/min and 20 K/min and more preferably between 3 K/min and 15 K/min. The heat treatment can be performed, for example, in a furnace. The maximum temperature in step B is in particular greater than the maximum temperature in step A. It is not ruled out that a heat treatment according to step B initially encompasses a treatment for a first period of time in the indicated temperature conditions and subsequently for a second period of time as long as it is ensured that the temperatures and times stated herein are satisfied overall. It is nevertheless preferred that the heat treatment according to step B takes place in one step, i.e. without the minimum temperature being undershot during step B.

The heat treatment according to step B is preferably performed at a pressure of 95 to 110 kPa, in particular at atmospheric pressure.

In one alternative embodiment, the step can be performed under elevated pressure, in particular in the case of overpressure of more than 5 Pa in comparison with the ambient pressure. Overpressure can help to keep the ambient atmosphere out of the furnace used if operation is in a low-oxygen or substantially oxygen-free atmosphere. An elevated pressure can also have an influence on enthalpy so that elevated pressure can save energy. In this embodiment, an overpressure of 10-1000 kPa in comparison with the atmosphere which surrounds the heat treatment apparatus is desired.

In another preferred embodiment, an underpressure in comparison with the ambient atmosphere or even a vacuum is desired. The requires the hermetical sealing off of the interior of the furnace with respect to the ambient atmosphere and has the advantages that the process atmosphere in the interior of the furnace can also be kept largely oxygen-free or low-oxygen in the case of outgassings during the conversion, decomposition or carbonizing processes. Outgassing products which split off from the original carbon compound are consequently directly extracted and removed from the atmosphere surrounding the process material. Typical pressures preferably extend absolutely from 0.01 to 95 kPa. In one embodiment, the vacuum is at least -5 kPa or at least -15 kPa in comparison with the ambient pressure.

In one preferred embodiment, the indicated temperature in step B can be maintained for a period of at least 1 minute or at least 5 minutes, in particular from 5 minutes to 600 minutes. In further embodiments, the duration of step B is at least 15 minutes or at least 25 minutes. The duration of step B can be restricted to at most 500 minutes or at most 400 minutes. In one embodiment, the duration is up to 150 minutes or up to 90 minutes. In one preferred embodiment, heat treatment step B follows on from heat treatment step A, in particular heating to the higher temperature of the second heat treatment step is performed directly after the first heat treatment step without interim cooling.

In another preferred embodiment, different furnaces are used for the first and the second heat treatment step. In one embodiment, the first thermally processed intermediate product is comminuted after step A, but prior to step B. This facilitates or makes an optional further comminuting step after step B superfluous. This is particularly advantageous since the composite material after step B is significantly harder and can only be comminuted with a very high degree of outlay. In one embodiment, the thermally processed intermediate product cools after step A and prior to step B partially or completely (i.e. to room temperature 20° C.). In particular, it can also be expedient, for the transport of the intermediate product after temperature treatment step A, to keep this intermediate product in a controlled process atmosphere such as, for example, with the exclusion of oxygen or even in a pure inert noble gas atmosphere (e.g. argon) or in an underpressure or vacuum. In one embodiment, the method comprises, after the heat treatment step A, but prior to heat treatment step B, the step of transporting the thermally processed intermediate product with the exclusion of water vapor and/or the exclusion of oxygen, or the step of transporting the thermally processed intermediate product in a pure noble gas atmosphere, such as e.g. argon, or the step of transporting the thermally processed intermediate product in an underpressure or in a vacuum.

The indicated minimum temperature for heat treatment step B should not be undershot in order to ensure a complete conversion of the carbon compound to a coating which contains carbon. The indicated maximum temperatures should, however, not be exceeded in order to avoid the formation of carbides. Heat treatment step B is preferably performed for a period of at least 30 minutes, in particular at least 90 minutes and preferably at least 180 minutes or at least 300 minutes. Heat treatment step B should be performed for a period of no more than 15 hours, in particular no more than 10 hours and particularly preferably no more than 8 hours. When selecting the correct period of time, a multi-ply layer composed of structured carbon is preferably obtained and preferably substantially all the OH groups are split off.

Heat treatment step B preferably follows on from the heat treatment step described above with a lower temperature. Heat treatment step A serves in particular the purpose of at least partial removal of any liquids and at least partial conversion of the carbon compound. Heat treatment step B preferably serves the purpose of at least partial conversion of the carbon compound to structured carbon and pyrolysis or carbonizing of the carbon compound which remains after step A. The indicated temperature range has been shown to be expedient since a substantial conversion is achieved and the formation of silicon carbide (SiC) is reduced or avoided. During heat treatment or conversion of the carbon compound, a carbon-containing coating which contains structured carbon or is composed of structured carbon is preferably generated. The decomposition is performed in particular with the exclusion of atmospheric oxygen and preferably with the exclusion of other oxidizing gases or liquids.

The term “coating” or “carbon-containing coating” means that the silicon is surrounded or covered at least partially, in particularly substantially completely by the carbon-containing product of the heat-treated carbon compound. This includes a thin coating as well as a carbon matrix into which the silicon is embedded.

The specific surface of the composite material can be adjusted in a targeted manner by suitable selection of the temperature in step B. Lower temperatures lead to higher specific surfaces, higher temperatures to smaller specific surfaces.

### Comminution

In one embodiment, the silicon is comminuted prior to the thermal processing, in particular prior to step A. The comminution can comprise breaking, breaking up, deagglomeration, rolling, shredding, fragmentation and/or milling. The comminution can take place in the low-oxygen atmosphere mentioned above and/or in a suitable process liquid (e.g. the dispersant). In one preferred embodiment, paraffin is used as a dispersant. Paraffin ensures, during grinding of the silicon, an exclusion of air from the Si surfaces which are newly produced during milling. In another preferred embodiment, paraffin serves simultaneously as a dispersant and as a carbon source. The silicon is milled in particular to a particle size D90 of less than 500 nm or less than 300 nm. In one embodiment, the particle size D90 is at least 50 nm. The particle size can be measured by means of dynamic light diffusion or by means of REM. It is advantageous to comminute the silicon prior to heat treatment, in particular immediately before heat treatment, since new silicon surfaces are generated by the comminution. These surfaces are initially not covered with an oxide layer and it is to be expected that the natural oxide layer which forms immediately is comparatively thin or is substantially not yet present as a result of the comminution, which can prove to be advantageous. Silicon dioxide forms silicates which increase the internal resistance of the battery with lithium during charging of the battery. Active material (silicon and lithium) is converted by reaction of SiOₓ with lithium until the SiOₓ layer is completely converted. In this case, lithium is lost for the charge carrier transport of the battery and the internal resistance of the battery is increased. This is, however, undesirable and is preferably minimized.

Alternatively or in addition to the comminuting step of the silicon prior to step A, the first thermally processed intermediate product is optionally comminuted, in particular milled. In particular a free-flowing intermediate product is obtained which can be effectively further processed. A further advantage is that any further comminution of the silicon-carbon composite material after step B is significantly easier if the thermally processed intermediate product has already been comminuted. A comminution of the thermally processed intermediate product to a particle size D90 of less than 50 µm or less than 35 µm is advantageous. The D10 value of the particle size relative to the mass distribution of the particles can be more than 500 nm.

In one preferred embodiment, graphite can be added before or after the comminution step to the thermally processed intermediate product in order to obtain a blend. The blend can then undergo the heat treatment step according to step B. The proportion of graphite is preferably selected so that the desired carbon proportion in the composite material is maintained.

In one embodiment, the silicon-carbon composite is comminuted after step B, in particular to a particle size D90 of more than 1 µm or in a range from >1 µm to 35 µm. However, a particle size distribution is aimed at or set, the D50 value of which is greater than the D50 value of the particle size distribution of the silicon particles prior to the thermal processing with carbon compound carbon compound. The comminution is expedient to obtain a composite material in particle form which can be effectively processed further to form pastes or slurries. Such slurries or pastes serve, when selecting suitable binders and additives, to apply the Si/C composite onto metal foils (preferably Cu foil) in order to thus produce anode surfaces. The comminution can preferably be restricted to the breaking of smaller Si/C composite agglomerates, in particular if the thermally processed intermediate product was comminuted, in particular also if hydrocarbons, such as e.g. paraffin, were used as a carbon source. It has been shown that fewer solid sintered bodies are formed in step B if the intermediate product was already comminuted, in particular if paraffin is used as a carbon source. As a result of this, the energy requirement of the method becomes significantly lower overall. The generation of new uncoated silicon surfaces during comminution after temperature treatment is furthermore minimized or prevented.

In one embodiment, the composite material is sieved, in particular to largely or entirely exclude particle sizes of smaller than 500 nm and greater than 35 µm. The composite material preferably has a D10 value of >500 nm and/or a D90 value of <35 µm in terms of its mass-related particle size distribution.

### Composite Material

A silicon-carbon composite material is also according to the invention, in particular which can be obtained according to the method described herein. The composite material is characterized by particularly low Coulombic losses if it is used in a battery. In particular, the material in the half cell test has an average Coulombic efficiency over 1000 charging/discharge cycles of at least 99.5% in the case of a charging capacity of at least 1000 mAh per g silicon, in particular of 1200 mAh per g silicon or more. The composite material can, in the half cell test, have a specific discharging capacity of at least 1000 mAh per g silicon or at least 1200 mAh per g silicon over more than 1000 charging/discharging cycles.

The composite material can have a silicon proportion of at least 20 wt.-%, at least >40 wt.-%, at least 51 wt.-%, in particular at least 60 wt.-%, at least 70 wt.-% or at least 80 wt.-%, more preferably at least 90 wt.-%, most preferably at least 95 wt.-%, relative to the total mass of the material. In one embodiment, the proportion is at most 99 wt.-% or at most 95 wt.-%.

The composite material can have a carbon proportion of 1 to 60 wt.-% relative to the total mass of the material, in particular at least 5 wt.-% or at least 9 wt.-%. In specific embodiments, the composite material can also have a carbon proportion of less than 1 wt.-% relative to the total mass of the material. A sufficiently high carbon proportion reduces the Coulombic losses of a battery cell produced with the composite material. The initial capacity is indeed lower in the case of a high carbon proportion in comparison with a lower proportion with a correspondingly higher silicon proportion. However, the capacity stabilizes quickly and at a surprisingly high level after an initial drop. The carbon proportion should nevertheless be upwardly restricted, in particular to at most 55 wt.-%, at most 50 wt.-% or at most 25 wt.-%. The carbon proportion may contain a proportion of graphite in addition to the carbon which has originated from the carbon compound.

In one preferred embodiment, the silicon and carbon content of the composite material can be adjusted for the anode side so that charging capacity and the cycle stability are in balance with the charging capacity and cycle stability of the cathode side of the battery. It is conceivable in this case that the composite material arising from the thermal treatment is mixed as a “drop-in replacement” in such a manner with graphite materials known from the prior art as a blend that the desired balanced (anode side and cathode side) battery capacity is produced.

The material is preferably present in the form of composite materials, in particular with a particle size D90 of less than 50 µm, less than 20 µm or less than 10 µm. In one embodiment, the particle size D90 is more than 1 µm. In one embodiment, the composite material has substantially no particles which are smaller than 500 nm. In particular, the D10 value is > 500 nm relative to the mass distribution of the particles.

The composite material optionally has substantially no particles which are larger than 35 µm or larger than 25 µm or larger than 20 µm or larger than 10 µm. Particles smaller than 500 nm and/or particles larger than 35 µm can optionally be largely removed by filtering.

In one embodiment at least a plurality, in particular the majority or all the composite particles comprise at least two silicon particles per composite particle. The silicon particles have in particular particle sizes D90 of less than 300 nm or less than 200 nm. The measurement of the particle size in the composite material can be performed by means of REM. In the case of doubt, the Martin diameter is meant.

The specific surface of the composite particles can be up to 300 m²/g, in particular in the range from 40 to 300 m²/g. In particular, the specific surface lies in a range from 10 to 100 m²/g. The specific surface can be measured with the BET method (e.g. according to DIN ISO 9277:2014). It has been shown to be advantageous to set smaller specific surfaces. As a result of this, parasitic reactions can be reduced.

### Use and Battery Cell

The use of the composite material described herein as an anode material in a battery cell, optionally with the addition of further additives such as e.g. graphite, is also according to the invention. In the anode material, the mass ratio of carbon to silicon can be at most 1:1, preferably at most 4:10, in particular at most 2:10 or at most 1.5:10. The anode material contains the composite material according to the invention. As a result of the high proportion of silicon, the maximum charge of a correspondingly equipped battery can be significantly increased. This mass ratio is preferably already adjusted in the method according to the invention by the selection of the quantity of silicon and carbon compound. A lithium-ion battery cell which contains the anode material is also according to the invention.

A battery cell comprising an anode which is composed at least partially of the composite material described herein is likewise according to the invention. The anode is optionally composed by at least 10 wt.-%, in particular at least 20 wt.-% or at least 60 wt.-% of the composite material. In addition to the composite material, the anode can possibly contain further carbon, e.g. in the form of graphite and/or carbon black and/or binding agents.

The battery furthermore preferably has a battery housing, a cathode, a separator and an electrolyte. Among others, standard electrolytes such as LP30 in which the conducting salt LiPF₆ is dissolved in 1 M solution of ethylene carbonate and dimethyl carbonate (EC:DMC =1:1) are considered. The electrolyte added to the battery cell/half cell can contain additives, in particular in an overall proportion of up to 15 wt.-% or up to 12 wt.-% relative to the mass of the electrolyte. In particular, the electrolyte (e.g. LP30) can contain up to 10 wt.-% FEC (fluoroethylene carbonate) and/or up to 2 wt.-% VC (vinylene carbonate) relative to the mass of the electrolyte. The additives can be selected from FEC (fluoroethylene carbonate), VC (vinyl carbonate), LiBOB (lithium-bis(oxalato)borate) and combinations thereof. These additives can improve the conductivity of an intermediate phase (SEI) between active material and electrolyte. However, these additives can lead to the formation of gas at higher temperatures (e.g. 50-60° C.). One of the advantages of the invention is that the additives in battery cells with the composite material can be used in reduced quantities, in particular in quantities of less than 10 wt.-%, or less than 3.0 wt.-% or less than 0.5 wt.-% relative to the mass of the electrolyte. The proportion of additives can optionally be at least 0.1 wt.-% or at least 1 wt.-%. In one preferred embodiment, the invention comprises battery cells which are substantially free from the stated additives.

The procedure of the method for producing a carbon-coated silicon anode is represented below:
M1: Si powder is mixed, for example, with a solution of ethylene glycol and saccharose as a carbon compound. Alternatively, ethylene glycol as the dispersant can be replaced by hydrocarbons, such as e.g. paraffins. It is also possible in this context to use paraffin as a carbon source and largely or completely dispense with saccharose or other carbohydrates.
Process T1 (Step A): The dispersion is heated to approx. 180° C.; the temperature is maintained until the solvent is evaporated, the sugar is caramelized and structures have formed. The process is realized in a nitrogen and/or protective gas atmosphere (protective gas can optionally also be dispensed with). When using paraffin as a carbon source and/or dispersant, the dispersion is heated to a temperature in the range from 120° C. to 700° C., preferably between 150° C. and 600° C.
Z1: After the process T1, the intermediate product is optionally comminuted. Defined particle size distributions can be aimed at in this case. The aim in particular is to realize the particle size close to the particle size of the desired end product so that ideally no further comminuting steps are required any more after T2 (at most still to comminute looser agglomerates). When using paraffin as a carbon source and/or dispersant, the end particle size can be achieved even without interim comminuting since large agglomerates which potentially arise can also be easily broken up again after the subsequent steps of the method according to the invention.
M2: The product can optionally at this point be mixed with graphite in order to jointly complete the subsequent thermal process for the formation of a blend material.
Process T2 (Step B): A change is made to a different process device in the case of which the material is threated thermally at higher temperatures. The temperature is increased in a nitrogen and/or argon and/or protective gas atmosphere and/or reducing atmosphere to 750° C. up to 2600° C. and maintained, preferably to 750° C. to 1100° C., until the transition of the carbon compound to structured carbon is completed to the desired extent. A composite material of silicon particles which are embedded into a carbon matrix is produced.
Cooling the material in a N2 atmosphere, alternatively and preferably Ar atmosphere or in a vacuum, to room temperature.
Z3: The material can optionally be comminuted and/or sieved.

### FIGURES

FIG. 1 compares Raman spectra of the composite material according to the invention according to Example V and of silicon and graphene nanosheets;

FIG. 2 shows an XRD spectrum of the graphene nanosheets;

FIGS. 3A/B shows the results of a performance test in relation to the extent of the secondary reactions of two variants of the composite material in battery test cells;

FIG. 4 shows the degradation properties of unprotected and protected silicon in battery test cells;

FIG. 5 shows the specific discharging capacity of a battery cell according to the invention in the half cell test after a plurality of charging cycles;

FIG. 6A shows an REM image of a silicon-carbon composite material obtained according to the invention;

FIG. 6B shows an REM image of a silicon-carbon composite material obtained according to the invention which was used for the EDX measurements (described further below).

FIG. 7 shows the specific charging capacity of a battery cell according to the invention, based on paraffin as a carbon compound, in the half cell test with a plurality of charging cycles.

FIG. 8A shows the temperature-time profile of the TGA measurement process.

FIG. 8B shows the TGA profile, with a change in mass in percent starting from 100% starting synthesis mass, as a function of the temperature reached for the synthesis from Si nanopowder, saccharose und a simple bivalent alcohol as a dispersant with a mass ratio Si:Saccharose:Dispersant of 1:0.556:1.666.

FIG. 8C shows a mass spectrometry analysis, associated with FIG. 8B, of the exhaust gases which escape from the measurement chamber together with the nitrogen throughflow which is fed into the measurement chamber.

FIG. 8D shows the TGA profile, with a change in mass in percent starting from 100% starting synthesis mass, as a function of the temperature reached for the synthesis from silicon nanoparticles (Si) and white oil (paraffin) with a mass ratio Si:Paraffin of 1:5.

FIG. 8E shows a mass spectrometry analysis, associated with FIG. 8D, of the exhaust gases which escape from the measurement chamber together with the nitrogen throughflow which is fed into the measurement chamber.

FIG. 9 shows the viscosity of a dispersion of silicon nanoparticles and white oil.

FIG. 10 shows the carbon compounds found with an XPS measurement on the surface of a synthesis product which was obtained from silicon nanoparticles and paraffin oil in a mass ratio 1:4.3. Typical temperature treatment steps A and B were used and a nitrogen atmosphere was ensured for these starting substances.

### EXAMPLES

### Production of a Silicon-Carbon Composite Material

The method according to the invention can be embodied in various configurations. In particular, it can be used with or without dispersant. The mass proportions of silicon and carbon can be varied. The invention is not restricted to the following examples.

### Example I

Silicon and saccharose are mixed with one another in a dispersant. Ethylene glycol was used as the dispersant. Saccharose served as a carbon compound. The mass ratio in the mixture (Silicon : Saccharose : Dispersant) was approx. 2:10:15.

The mixture was transferred into a crucible for heat treatment. The crucible had a capacity which exceeded the volume of the mixture to prevent the mixture running over as a result of foaming.

The crucible was moved into a push-through furnace for the first heat treatment (step A) and treated there for a period of 15 hours at 180° C. The transition temperature of the saccharose is 160° C. The heat treatment took place in a nitrogen atmosphere. During the heat treatment, the saccharose lost approx. 15% of its mass and it was caramelized.

The product of the first heat treatment (thermally processed intermediate product) was subsequently comminuted in such a manner than an average bulk material density of 1.09 g/cm³ was obtained.

The comminuted intermediate product was subsequently transferred into a rotary kiln and heat-treated for a second time there at 1600° C. for a period of 6 hours (step B). The heat treatment took place in a nitrogen atmosphere. The loss of mass was approximately 60%. Thereafter, the obtained silicon-carbon composite material was milled with a multi-stage roller mill to a particle size D90 in the range from 10 to 20 µm. The composite material had a silicon proportion of 50 wt.-% and carbon proportion of 50 wt.-%.

### Example II

Silicon and saccharose were mixed with one another without dispersant. Saccharose served as a carbon compound. The mass ratio in the mixture (Silicon : Saccharose) was approx. 9:5.

The mixture was transferred into a crucible for heat treatment. The crucible had a capacity which corresponded to the volume of the mixture since a running over of the mixture was not to be feared due to the lack of dispersant.

The crucible was moved into a push-through furnace for the first heat treatment (step A) and treated there for a period of 1 hour at 180° C. The heat treatment took place in an air atmosphere. During the heat treatment, the saccharose lost approx. 15% of its mass and it was caramelized.

The product of the first heat treatment (thermally processed intermediate product) was subsequently comminuted in such a manner than an average bulk material density of 1.05 g/cm³ was obtained.

The comminuted intermediate product was subsequently transferred into a rotary kiln and heat-treated for a second time there at 1400° C. for a period of 1 hour (step B). The heat treatment took place in a nitrogen atmosphere. The loss of mass was approximately 25%. Thereafter, the obtained silicon-carbon composite material was milled with a multi-stage roller mill to a particle size D90 in the range from 10 to 35 µm. The composite material had a silicon proportion of 90 wt.-% and carbon proportion of 10 wt.-%.

### Example III

Silicon with an average particle size of 100 nm, graphene oxide and saccharose were mixed with one another in isopropanol as a dispersant. Saccharose served as a carbon compound. The mass ratio in the mixture (Silicon : Saccharose : Graphene oxide : Isopropanol) was approx. 20:100:1:850.

The mixture was initially milled together in a ball mill. The dispersant was subsequently fully evaporated at 80° C. in an air atmosphere and the remaining mixture was transferred into a crucible.

The crucible was moved into a synthesis furnace for the first heat treatment (step A) and treated there for a period of 15 hours at 180° C. The heat treatment took place in a nitrogen atmosphere.

The obtained intermediate product was subsequently heat-treated for a second time at 1280° C. for a period of 6 hours (step B). The heat treatment took place in a nitrogen atmosphere. Thereafter, the obtained silicon-carbon composite material was milled in a mortar. The composite material had a silicon proportion of 50 wt.-% and a carbon proportion of 50 wt.-%.

### Example IV

Silicon (31.01 wt.-%), graphene oxide (0.09 wt.-%) and saccharose (17.23 wt.-%) were mixed with one another in a dispersant (51.67 wt.-%). Ethylene glycol was used as the dispersant. Saccharose served as the carbon compound.

The mixture was transferred into a chamber furnace for the first heat treatment (step A) and treated there for a period of 15 hours at 180° C. The heat treatment took place in a nitrogen atmosphere.

Heat treatment was subsequently performed for a second time at 1100° C. for a period of 6 hours (step B). The heat treatment took place in a nitrogen atmosphere.

### Example V

Any amount of a silicon powder with a particle size of D90 = 150 µm, which also has a native oxide layer on the surface, is mixed with a sufficient amount of ethylene glycol so that the powder is entirely covered by the liquid. The ethylene glycol should bring about that the silicon does not come into contact with oxygen during the subsequent milling.

A corresponding amount of saccharose was added to the above-mentioned mixture and stirred until the sugar dissolved in the ethylene glycol. The computational or experimentally obtained yield from the thermal conversion of saccharose to structured carbon at a temperature of 850° C. is approximately 20% in relation to the mass of the saccharose used. The mixture is accordingly selected so that a ratio between silicon and structured carbon of 9:1 arises.

The mixture is transferred to a zirconium oxide milling cup with zirconium oxide milling balls with a diameter of 3 until the milling balls are just covered by the mixture. The milling cup is subsequently closed and inserted into a planetary ball mill and milled at a speed of 500 rpm.

The resultant dispersion is filled into a ceramic crucible and placed into a synthesis furnace. A thermal synthesis process is subsequently performed in a protective nitrogen atmosphere in the following sub-steps:
a. Raising the temperature to 180° C. and maintaining this temperature for 15 hours, with the objective of evaporating the ethylene glycol and caramelizing the saccharose
b. Raising the temperature to 850° C. and maintaining the temperature for 6 hours, with the objective of thermally decomposing the carbon source as completely as possible and producing a multi-ply layer composed of structured carbon around the silicon particles
c. Cooling to room temperature in a protective atmosphere

The product of the synthesis is comminuted with a mortar in order to break up agglomerates and processed into a compressible paste with the addition of carbon black, binding agent and deionized water in a three-roll mill.

The paste is applied with a blade to form a layer on a copper foil and is subsequently dried.

Elements are punched out or cut out from the coated copper foil and processed further to form battery cells (for details see half cell test below).

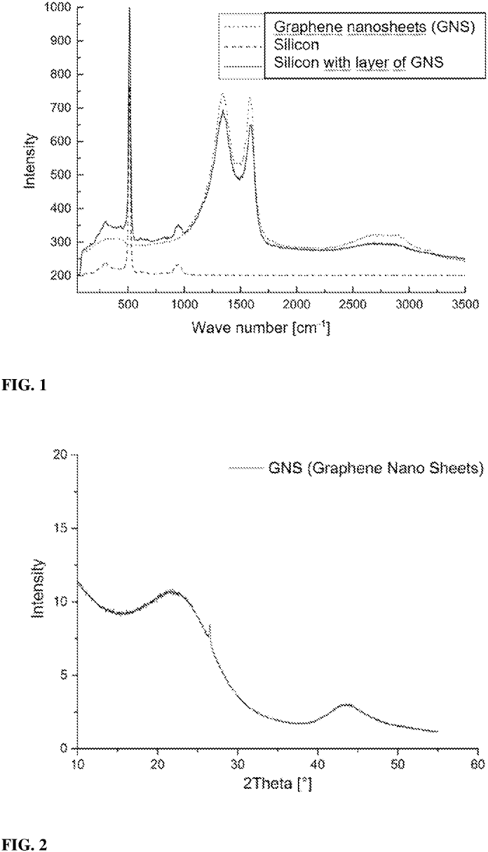

A Raman spectrum of the product of the method was recorded and is shown in FIG. 1. Superimposed Raman spectra of the produced material are shown, as well as, for the purpose of comparison, the spectra of pure silicon and pure graphene nanosheets (GNS). It is apparent that the material synthesized here has all the features of silicon and GNS (cf. also S. Stankovich et al., Carbon 45 (2007) 1558-1565). It is apparent that the material produced involves silicon coated with several non-coherent graphene layers. FIG. 2 shows an XRD spectrum of GNS.

### Evaluation of the Results

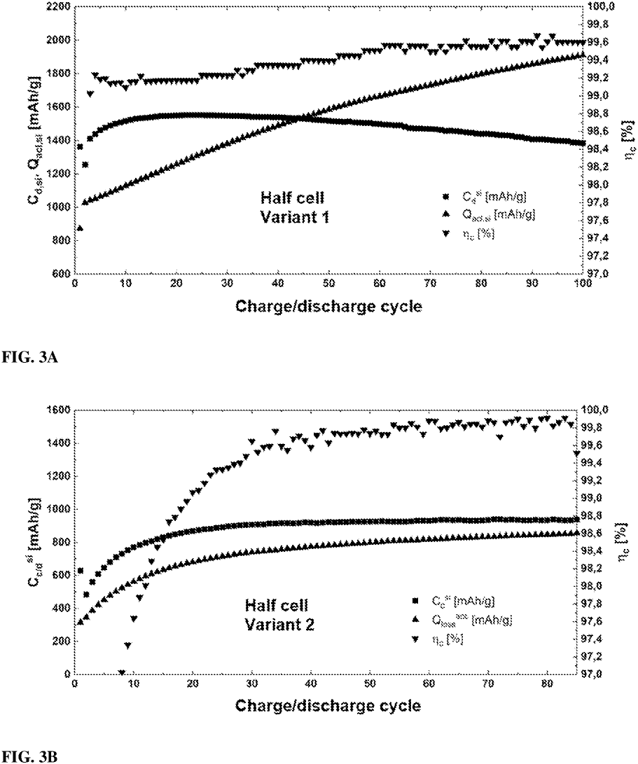

Test cells were produced using the composite material according to the invention. The amount of electric charge which flows during charging and discharging was measured by repeated electric charging and discharging of battery test cells. Of particular interest here is the extent to which the specific level of charge which can at most be removed during discharging reduces (degradation of the battery) and how high the ratio is between the charge supplied during charging and the charge removed during subsequent discharging. It can be determined from this the extent to which undesirable secondary reactions occur. This value is particularly important in the case of the first cycle since unavoidable secondary reactions take place here (formation of a passive layer on the negative electrode). It was possible to significantly reduce the extent of these secondary reactions through the use of the method according to the invention. FIG. 3 shows on the basis of two different variants of test cells with an Si/C composite anode how the method according to the invention can be used to significantly restrict the extent of the secondary reactions.

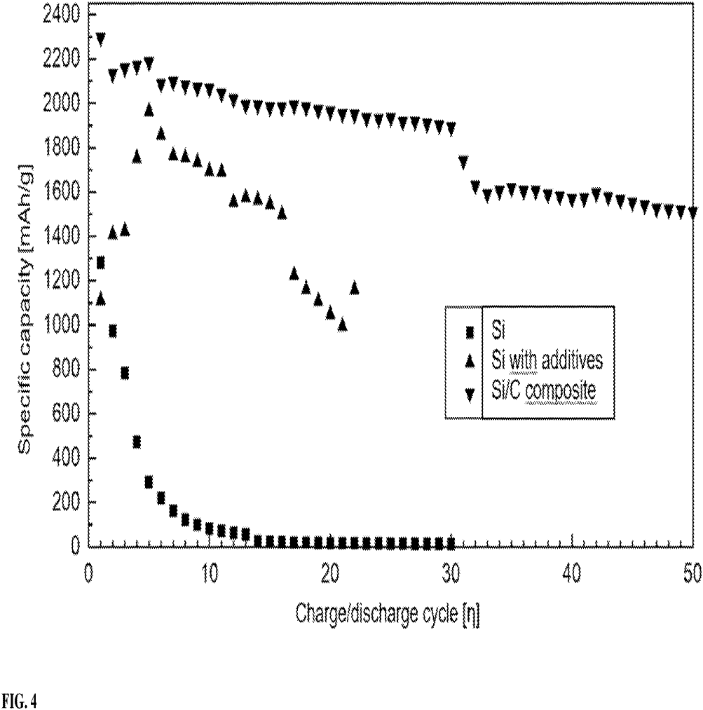

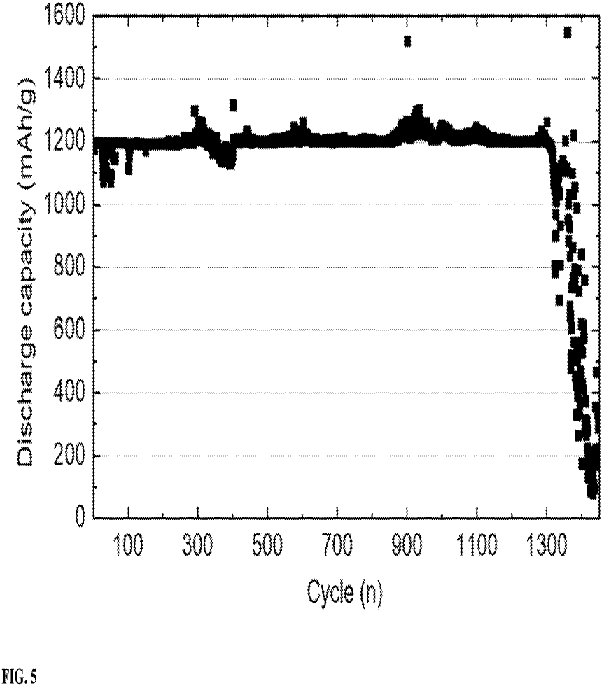

Variant 2 (FIG. 3b) shows in this case significantly reduced charge losses and thus also a lower degree of secondary reactions than in the case of variant 1 (FIG. 3a). This was achieved by improved process management. The degradation of the material in relation to its available specific storage capacity could also be significantly reduced through the use of the method. FIG. 4 shows the differences in the degradation properties of battery cells with silicon anodes with unprotected silicon (once with and once without electrolyte additives) in comparison with carbon-coated silicon. It is apparent that the usable capacity of the cells with unprotected silicon reduces significantly over the course of the charging/discharging cycles, while the usable capacity only falls slightly in the course of the cycles in the case of the variant with a carbon protective layer.

### Half Cell Test

In order to test the cycle stability, a half cell in the form of a button cell was produced using the silicon-carbon composite material in an Si/C-based electrode. A half cell is a test cell in the case of which the Si/C-based electrode is tested against lithium as a counter electrode. The function of the Si/C composite material as the electrode material is tested in a targeted manner with the test.

In order to obtain an Si/C electrode from the composite material, the comminuted Si/C composite (e.g. D90 < 35 µm) was added together with carbon black to a water-soluble sodium-alginate binder and mixed in a speed mixer homogeneously at up to 3000 revolutions per minute. The alginate binder was produced according to the formula of Liu et al. (Liu, Jingquan et al. “A high-performance alginate hydrogel binder for the Si/C anode of a Li-ion battery.” Chemical communications 50 48 (2014): 6386-9). Deionized water:sodium alginate:CaCl2 was added in the mass ratio 100:3:0.03 and evaporated while stirring continuously at approx. 80° C. to a residual solid content of approx. 10 wt.-% water.

In a proportion relative to the pure solid content of the alginate binder, 65% Si/C composite with 25% solid content of the alginate binder and 10% carbon black were mixed in the speed mixer.

The water content of the binder can where necessary also be adapted in order to influence the rheology of the arising paste/slurry.

After the mixing of the components, the resultant paste is homogenized in a three roll mill and particle agglomerates are broken up. The initial gap of the three roll mill is preferably set to, for example, 20 µm in order to subsequently ensure a layer application (wet application thickness) during printing of approx. 30 µm.

The resultant paste is printed onto a thin Cu foil after the rolling process and subsequently dried. The environmentally friendly solvent (water) is largely removed from the printed layer so that the binder can be adhesively cross-linked effectively with the surface of the Cu foil. It is dried so that water is substantially fully removed from the printed material with the exclusion of air.

Circular coins with a defined diameter (e.g. 14 mm, 16 mm or 18 mm) are punched out from the Cu foil printed with Si/C composite and the proportion of Si/C active material in these coins is weighed and the respective Si and C proportions in the active material are calculated from the synthesis conditions.

The theoretical specific maximum capacity per gram active material (Si/C composite material) can be calculated from this.

The button cells (half cells) are subsequently assembled with the exclusion of air in an inert atmosphere (e.g. argon). The coin composed of composite material is placed centrally onto Cu foil with the Cu side into the first housing half of the button cell. In this case, the housing has a larger diameter than the punched-out coins.

A separator (e.g. glass fiber separator from Whatman with a thickness of 1 mm) was inserted concentrically onto the composite material likewise into the first housing half. The diameter of the separator is normally just as large or larger than that of the coin with Si/C material, but is likewise smaller than the inner diameter of the battery housing of the button cell. This separator is drizzled/soaked with the electrolyte mixture (see below). Approx. 100-200 µl is normally sufficient for this.

A sufficiently thick Li counter electrode is inserted concentrically onto the electrolytes drizzled in this manner in the half cell configuration. The thickness of the counter electrode is selected so that the availability of Li does not limit the performance of the half cell. The diameter of the Li coin again tends to be smaller or at most to be of the same size as the separator diameter.

A spacer with a suitable thickness and a spring is placed onto the Li counter electrode. Thereafter, the second housing half is placed concentrically and subsequently pressed onto the housing cover with a pressure of 6 tons so that the housing is subsequently tightly sealed.

A standard electrolyte (commercial name LP30) was used, comprising, in addition to the conducting salt (LiPF₆), ethylene carbonate EC: dimethyl carbonate DMC (ratio 1:1) and two additives, fluoroethylene carbonate FEC (10 wt.-%) and vinylene carbonate VC (2 wt.-%).

This half cell was then subjected to what is known as a forming process in the case of which targeted charging/discharge conditions are initially carried out with low charging rates before the cycle tests are performed. Forming was performed in each case with approx. 1/30 C (twice) using the CC method with a voltage limit of 100 mV.

Directly thereafter, for the purpose of testing, 1300 cycles with 1 C were performed at room temperature (20° C.), using the CC/CV method with the voltage limits 100 mV/ 1.5 V. CC denotes charging processes with “constant current” (fixed current value) up to a defined final voltage. CV denotes “constant voltage” (fixed charging voltage). The C rates (C/30, or 1C) indicate in what period of time the battery capacity is charged. 1 C corresponds to a charging process of the full capacity within an hour. C/30 means that the charging process lasts 30 hours. In the case of the stated voltage limit of 1.5 V, in each case only part of the maximum available capacity of the Si/C-based electrode is charged and/or discharged again.

For the half cell test, the specific charging capacity was restricted to 1200 mAh per g silicon.

A battery cell tester from the manufacturer Neware was used for the half cell test.

### Discharging Capacity

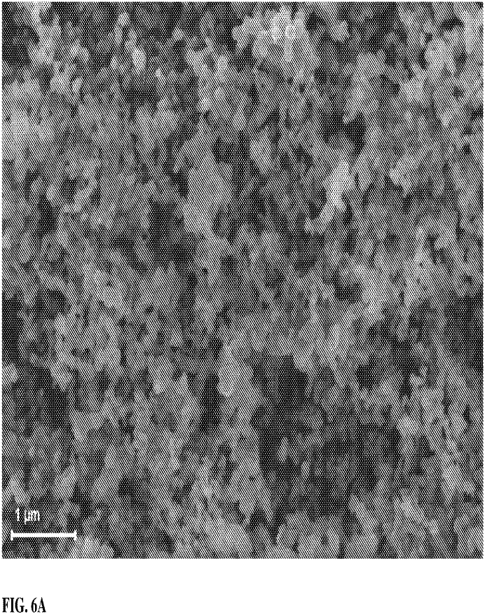

FIG. 5 shows the performance of the composite material according to the invention by plotting the discharging capacity in the half cell test described above as a function of the cycle number while restricting the specific charging capacity to 1200 mAh/g. It is clearly apparent that the starting value of the specific discharging capacity can be maintained over far more than 1000 cycles.

### EDX-REM Analyses

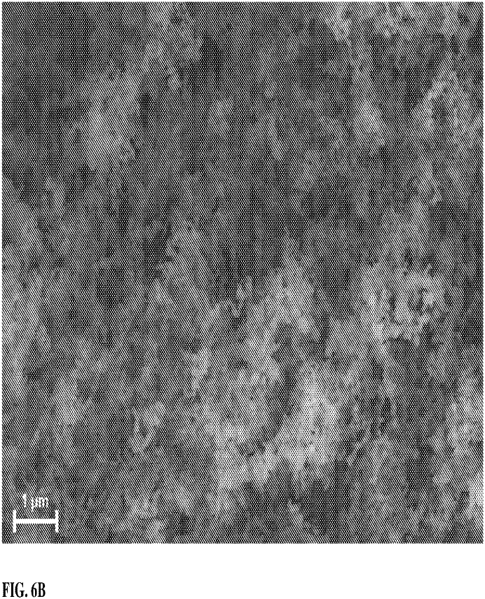

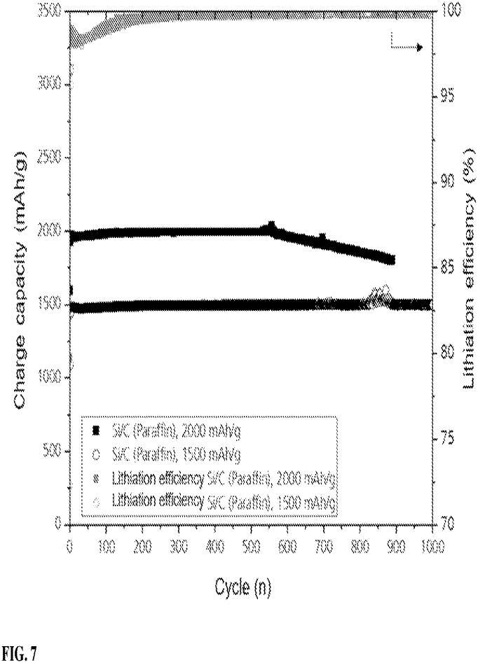

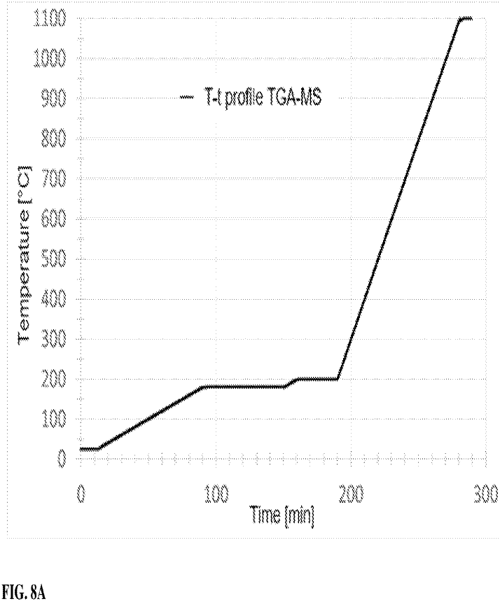

FIG. 6A shows an REM image of a silicon-carbon composite material obtained according to the invention. Silicon and paraffin in the mass ratio 1:4.3 were used for the synthesis of this composite material. The REM image was recorded in the case of 5.0 kV, an enlargement of 15,050 and a working distance of 4.8 mm.

FIG. 6B shows an EDX image. The composition of the silicon-carbon composite material was determined at four measurement points close to the surface in the case of 7.0 kV, an enlargement of 10,000 and a working distance of 4.5 mm by means of energy dispersive X-ray spectroscopy analysis (English abbreviation EDX; Quantax, Bruker Nano GmbH). The carbon proportion varies in a larger range, it exhibits a dependency on the selection of the measurement point and thus the orientation of the particle surfaces. It is assumed that the oxygen detected is due to the original oxide layer on the silicon particles.

Atomic percentage (%)

| | | | | |
|---|---|---|---|---|
| Measurement point | C | N | 0 | Si |
| Measurement point 01 | 2.272 | 1.916 | 2.672 | 93.140 |
| Measurement point 02 | 9.983 | 1.441 | 3.224 | 85.352 |
| Measurement point 03 | 1.218 | 1.072 | 2.206 | 95.504 |
| Measurement point 04 | 0.847 | | 1.210 | 97.944 |
| Average | 3.580 | 1.477 | 2.328 | 92.985 |
| Sigma: | 4.311 | 0.423 | 0.854 | 5.454 |

### Thermogravimetric Analysis (TGA)

Thermogravimetric measurements with downstream mass spectroscopic analysis of the arising or escaping reaction gases were performed. By way of example, two measurement results according to the invention are reproduced here. In both cases, a nitrogen atmosphere with a comparatively low volumetric flow was used during the thermogravimetric analysis (TGA). It was possible to demonstrate by means of additional tests on pure silicon wafers in the same atmosphere (without further additives) that a small residual oxygen quantity is present in the measuring apparatus which is present as a result of very small leakage paths in the seal of the measuring chamber at high temperatures or is introduced by the nitrogen flushing gas itself. The silicon wafers (in a nitrogen atmosphere) exhibited according to the same temperature-time profile, which was used for the TGA, an increased silicon oxide layer on their surface. Such tests are, however, expedient in an almost pure nitrogen atmosphere.

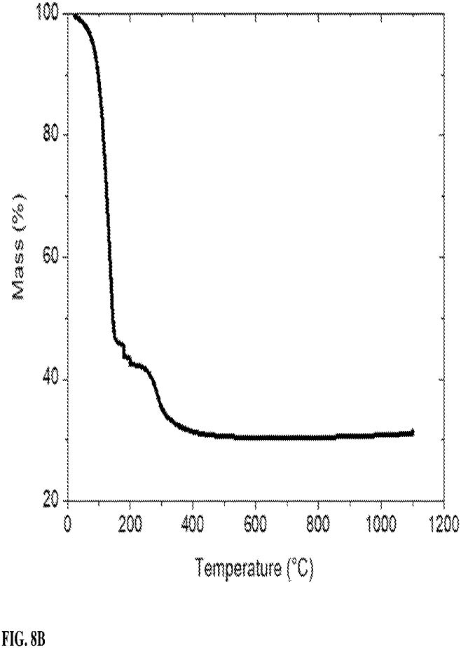

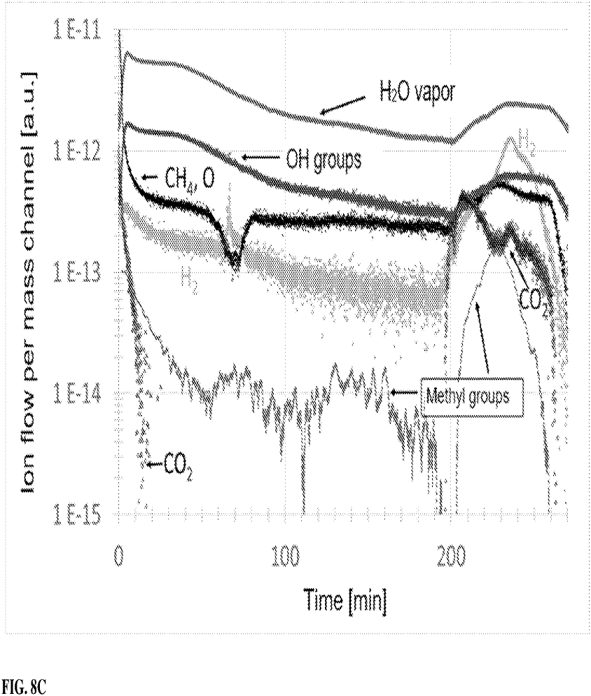

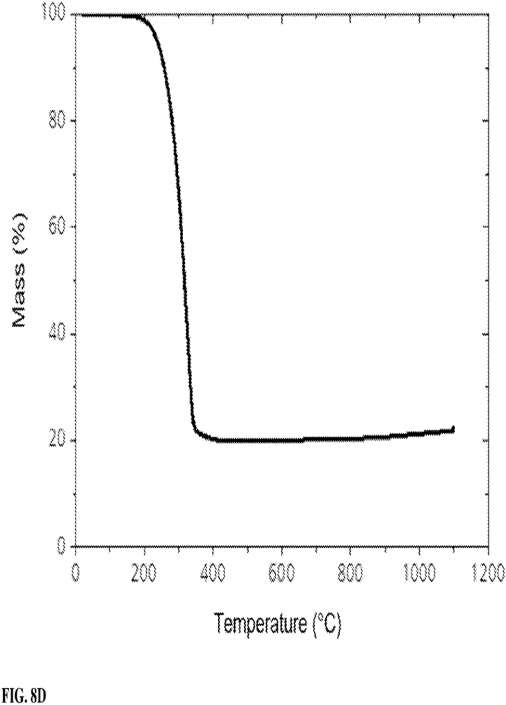

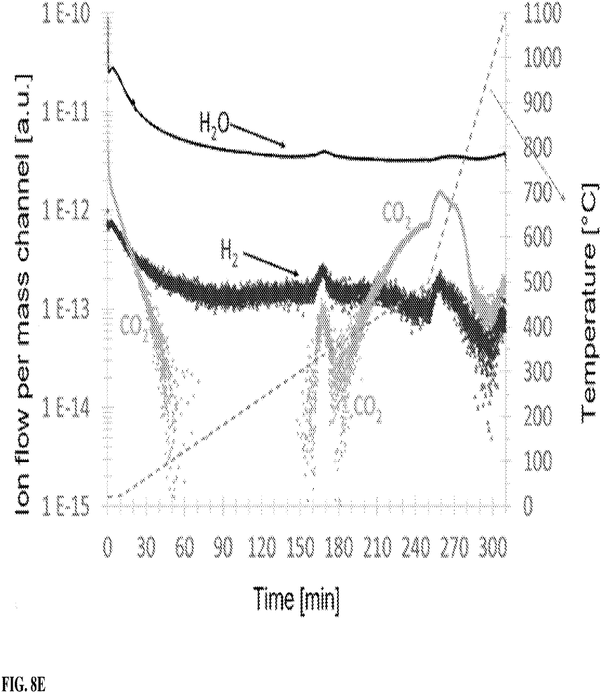

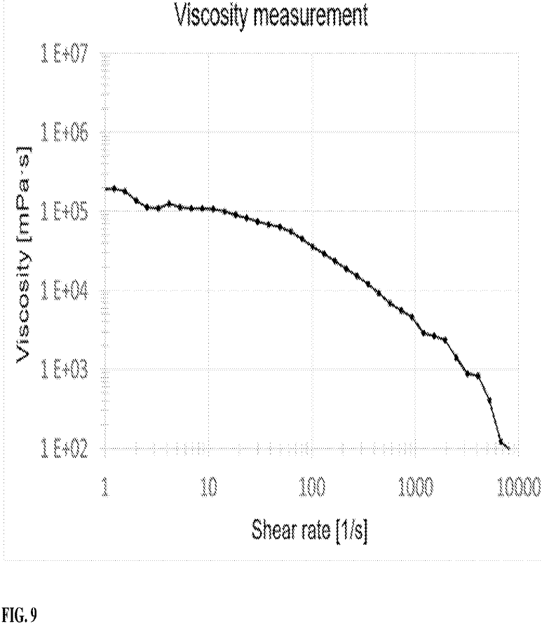

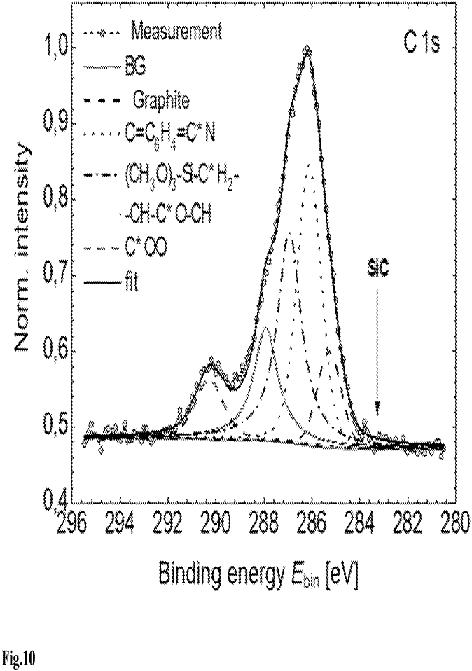

The temperature-time profile for the TGA was adapted to the measurement process and its limitations and is represented in FIG. 8A.

In the first example, a synthesis of silicon nanopowder, of saccharose and a simple bivalent alcohol as a dispersant was performed. The mass ratio of the starting substances was selected in the ratio of Si:Saccharose:Dispersant = 1:0.556:1.666. The total mass was selected to be comparatively small in order to be able to rapidly transport away the gases which escape in an industrial implementation of the method.

The associated TGA profile shows the change in mass in percent starting from 100% starting synthesis mass as a function of the temperature reached for the temperature-time profile used (FIG. 8B). It is apparent from this that various conversion processes which are normally executed in the first temperature treatment step A according to the invention are performed up to a temperature of slightly above 300° C. Further transitions within the normally separate second temperature transition step B no longer lead to abrupt changes in mass. A further conversion of the synthesis product is nevertheless performed here. Process gases escape in this case which are separated off or escape from the synthesis volume and initially lead to a continuous further reduction in mass of the synthesis volume. The slight increase in the synthesis mass above approx. 900° C. can be caused by virtue of the fact that a residual oxygen atmosphere reacts with the Si particles or the carbon source. As it was possible to show by means of the separate evidence of a TGA with a pure silicon wafer in a nitrogen atmosphere, the formation of a thin silicon oxide layer on the silicon surfaces is likely as long as residual oxygen cannot be fully excluded from the system.

In addition to the TGA, a mass spectrometric analysis of the exhaust gases which escape from the measuring chamber together with the nitrogen which has been fed in has been carried out (FIG. 8C). It is pointed out that a comparatively low nitrogen flushing gas throughflow was selected. The mass spectrometric analysis was performed qualitatively and an absolute scaling of the respective escaping substances was dispensed with. The mapping is furthermore restricted to a few key compounds or escaping gases which were analyzed as significant and relevant with the mass spectrometer. In terms of the temperature-time profile for the TGA (FIG. 8A) and the associated mass spectrometric analysis of the outgoing air flow, it is apparent that water vapor, methane, hydrogen and CO₂ as well as OH groups, methyl groups are still separated or split off from the synthesis volume to a significant degree at temperatures significantly above 300° C. (time profile >> 200 min) (FIG. 8C).

In the second example, a synthesis with two starting materials was performed, i.e. silicon nanoparticles (Si) and white oil (paraffin), wherein white oil simultaneously serves as a dispersant and carbon source. The synthesis composition was performed in the mass ratio Si:Paraffin of 1:5 (FIG. 8D). In contract to the first example, the first conversion of the synthesis composition is only performed above 200° C. and then initially continuously up to a temperature of approximately 350° C., which is why the maximum temperature of the first temperature treatment step A slightly above this temperature would be selected. It is, however, clear to the person skilled in the art that, by means of suitable selection of another hydrocarbon compound as a dispersant and carbon source, syntheses are also possible in the case of which the first conversion can be displaced toward higher (up to 700° C.) or lower temperatures. When selecting other hydrocarbon compounds, one would correspondingly typically select the maximum temperature of the first temperature treatment step A so that the greatest reduction in mass is already largely concluded before the temperature treatment step B begins.

In contrast to the synthesis from silicon, saccharose and a bivalent alcohol as a dispersant, no or only a very small degree of splitting off of water vapor, methane, methyl groups and OH groups is performed during the synthesis of silicon with white oil (FIG. 8E). Even hydrogen escapes only in two temperature ranges with a slightly increased rate into the gas atmosphere. Only CO₂ escapes again at temperatures significantly above 400° C. to a pronounced degree into the process atmosphere. It is to be assumed that process atmosphere tends to have a reducing effect instead of an oxidizing effect in temperature treatment step B. However, it was also observed here in the case of the TGA that a low residual oxygen concentration at temperatures above 900° C. can lead to oxidation of Si surfaces which are still exposed. It is known to the person skilled in the art how it is made possible in suitable production processes of the syntheses, in contrast to the TGA measuring structure, to suppress the residual oxygen concentrations.

### Rheology

The viscosity was determined with a rotational rheometer MCR 702 MultiDrive from Anton Paar. Measurements were performed in the Twin-Drive mode, in which the upper and the lower plate rotate in the opposite direction with the same rotational speed (50%/50%), in order to study high shear rate ranges. The plate-plate measurement geometry, with a profiled surface, makes it possible to prevent or minimize sliding effects during the measurement. The profiling of the plates has a pyramid structure. (0.2 mm x 0.1 mm). The measurement parameters were as follows: Plate-plate geometry with 0.3 mm measurement gap, room temperature 21.5° C., logarithmic shear rate of 0.05 - 100000 (in Twin-Drive mode), logarithmic measurement point duration of 60 s to 1 s.

During the measurement, the air supply to the chamber is reduced according to the judgement of the person skilled in the art in order to prevent rapid drying out of a dispersed powder mixture. The volumetric air flow in the measurements shown was 0.35 m³ h⁻¹. Moreover, a temperature chamber was used to protect the measurement from external influences.

Before each measurement, a waiting time is observed according to the judgement of the person skilled in the art (optionally between 1 and 10 minutes) since the paste is slightly sheared by application and it should achieve its actual state.

I/We claim:

1. A method for producing a silicon-carbon composite material, with the steps comprising:
mixing silicon particles, at least one carbon compound, and optionally at least one dispersant in order to obtain a mixture,
thermal processing of the mixture in at least two steps in the following sequence:
A. heat treatment of the mixture at a temperature which corresponds at least to the transition temperature of the carbon compound, in order to obtain a thermally processed intermediate product;
B. heat treatment of the thermally processed intermediate product at a temperature above 750° C., in order to obtain the silicon-carbon composite material,
wherein the silicon-carbon composite material has a silicon mass percentage of more than 80%,
wherein the silicon particles have a particle size D90 in a range from 500 nm to 50 nm.

2. The method according to claim 1, wherein at least step B, optionally also step A, is performed in a substantially oxygen-free atmosphere.

3. (canceled)

4. The method according to claim 1, wherein the temperature in step A is in a range from 150° C. to 700° C.

5-7. (canceled)

8. The method according to claim 1, wherein the thermally processed intermediate product is comminuted to a particle size D90 of less than 50 µm.

9. The method according to claim 1, wherein the mixture of silicon and carbon compound additionally contains structure-giving and/or catalytically acting additives.

10-12. (canceled)

13. The method according to claim 1, wherein the carbon compound is a carbohydrate.

14. The method according to claim 1, wherein particles of the product after temperature step A or of the intermediate product between temperature steps A and B are smaller than 500 nm and/or the particles larger than 35 µm are largely removed by filtering.

15. The method according to claim 1, wherein the mixture of silicon particles, at least one carbon compound, and optionally at least one dispersant has a viscosity of greater than 5000 mPa·s, measured with a rotational viscometer using opposite rotation, a shear rate of 100/s, and a temperature of 21.5° C.

16. (canceled)

17. The method according to claim 1, wherein the carbon compound alternatively or additionally comprises at least one carbon compound selected from the list of lignin, waxes, plant oils, fats, oils, fatty acids, rubber and resins, or wherein the carbon compound and/or the dispersant is a paraffin or paraffin oil.

18. (canceled)

19. The method according to claim 1, wherein the mixture of silicon particles, at least one carbon compound, and optionally at least one dispersant, further comprises lithium or a starting material which contains lithium.

20. A silicon-carbon composite material, which can be obtained according to the method of claim 1, with an average Coulombic efficiency over 1000 charging/discharging cycles of at least 99.5% in the half cell test with a specific charging capacity of at least 1000 mAh/g relative to the silicon mass in the composite,
wherein the composite material has a silicon proportion of 40 to 99 wt.-% and a carbon proportion of 1 to 60 wt.-%,
wherein the composite material is present in the form of composite particles with a particle size D90 of less than 50 µm.

21-22. (canceled)

23. The silicon-carbon composite material according to claim 20, with a particle size D10 of more than 500 nm relative to the mass distribution of the particles.

24. The silicon-carbon composite material according to claim 20, wherein at least a plurality, of the composite particles have at least two silicon particles per composite particle.

25. The silicon-carbon composite material according to claim 20, with a specific surface no greater than 300 m²/g.

26. The silicon-carbon composite material according to claim 20, with a specific surface which is no more than twice as large, as the specific surface of the silicon particles in the composite material.

27. The silicon-carbon composite material according to claim 20, with a specific discharging capacity of at least 1000 mAh/g relative to the mass proportion of the silicon in the composite material over more than 1000 charging/discharging cycles in the half cell test.

28. An anode for use in a battery cell comprising:
A silicon-carbon composite material with an average Coulombic efficiency over 1000 charging/discharging cycles of at least 99.5% in the half cell test with a specific charging capacity of at least 1000 mAh/g relative to the silicon mass in the composite,
wherein the composite material has a silicon proportion of 40 to 99 wt.-% and a carbon proportion of 1 to 60 wt.-%,
wherein the composite material is present in the form of composite particles with a particle size D90 of less than 50 µm, and
wherein the silicon-carbon composite material produced by the steps comprising
mixing silicon particles, at least one carbon compound, and optionally at least one dispersant in order to obtain a mixture,
thermal processing of the mixture in at least two steps in the following sequence:
A. heat treatment of the mixture at a temperature which corresponds at least to the transition temperature of the carbon compound, in order to obtain a thermally processed intermediate product;
B. heat treatment of the thermally processed intermediate product at a temperature above 750° C., in order to obtain the silicon-carbon composite material.

29. A battery cell comprising the anode of claim 28.

30. The method according to claim 1, wherein the silicon particles are comminuted prior to the thermal processing and wherein paraffin is used as the dispersant.

31. The method according to claim 1, wherein the method includes a step for the removal of silicon dioxide from the surface of the silicon particles by etching the silicon particles by using HF, KOH, NH₄F, NH₄HF₂, LiPF₆, H₃PO₄, XeF₂, SF, or a combination thereof.
